(19) United States
(12) Patent Application Publication
(10) Pub. No.: US 2021/0349922 A1
(43) Pub. Date: Nov. 11, 2021

(54) METHOD OF RECOGNIZING AN OBJECT IN AN IMAGE USING iMaG AUTOMATED GEOREGSTRATION SYSTEM GENERATED MULTI-ORBIT SATELLITE IMAGERY WITH A CADSTRAL DATA BASED IMAGERY BASE

(71) Applicants: Jane Huang Hsu, Forest Hills, NY (US); Sigmund Hsu, Houston, TX (US)

(72) Inventors: Shin-yi Hsu, Forest Hills, NY (US); Jane Huang Hsu, Forest Hills, NY (US); Sigmund Hsu, Houston, TX (US)

(21) Appl. No.: 16/867,548

(22) Filed: May 5, 2020

(51) Int. Cl. G06F 16/29; G06T 17/05; G06K 9/00; G06T 7/38; G01C 21/20

(52) U.S. Cl. CPC G06F 16/29; G06T 17/05; G06T 2207/30181; G06T 7/38; G01C 21/20; G06K 9/0063

(57) ABSTRACT

A method of generating a Virtual Geospatial Information System (VGIS) database for recognizing an object in an image. At least two images are input to the system, one of the images being a base image for scene registration. At least one orthoimage is generated with corresponding digital elevation model (DEM) data in a Virtual Earth Coordinate (VEC) System domain. The at least one orthoimage is registered to produce a registered image set. Georegistered imagery with scene content signatures is output for automated scene content analysis and automated change detection. In another embodiment, the method of generating a VGIS database for recognizing an object in an image includes the steps of: inputting at least two images, one of the images being a base image for scene registration; registering the at least one image in the virtual Earth or no-coordinate domain to produce a reduced drift geo-aligned image set; and outputting the geo-aligned imagery comprising at least one item chosen from a set of items consisting of: scene content signatures; signature libraries of the base images and the registered image set; georegistration variance score map; georegistration drift score database; and change detection.

### RELATED APPLICATIONS

The present application is related to U.S. Pat. Nos. 7,899,272 and 7,343,051 and hereby incorporates the teachings therein.

### FIELD OF THE INVENTION

The present invention relates to object recognition in an image and, more particularly to recognition of an object in a novel automated orthorectification and a novel scene alignment with cadastral database image using an optimal base applicable in both U.S. and non-U.S. areas.

### BACKGROUND OF THE INVENTION

In pattern recognition and remote sensing, object recognition is typically performed by gradually accumulating evidence from various sensors and from components within individual sensors. The first approach is usually referred to as intra-sensor integration, whereas the latter is referred to as inter-sensor integration from multi-orbit imagery. For this invention, inter-orbit and across-orbit integration are added.

Information extraction from multi-sensor, multi-orbit images is usually a more difficult procedure than information extraction from a single sensor image simply because multi-sensor, multi-orbit images are almost never spatially registered. For multi-orbit imagery, spatial overlap is rare, except in the case of stereo-imaging. Thus, the first step to multi-sensor and multi-orbit integration is typically to physically register the images as completely as possible even when a geoimage cannot be generated. However, in this georegistration process, three sets of new problems are encountered: (1) geo-inaccuracy of single-orbit imagery, (2) multi-orbit offset inherent in satellite's GPS pointing accuracy; and (3) terrain elevation effect to compound the pointing geo-inaccuracy. Since ground control points (gcp) are transferred from the base to the to-be-georegistered or simply aligned imagery, the geo-accuracy of the base must be better than the other half of the pair. An optimal base is first chosen.

The concept of “conditionally optimal” base was described in 2008 as U.S. Pat. No. 7,343,051, and in 2011 as U.S. Pat. No. 7,899,272. “Conditional Optimal” arises from the fact that the best current base is still offset by five meters.

Digital Orthophoto Quad (DOQ) or Digital Orthophoto Quarter Quad (DOQQ) imagery generated by the United States Geological Survey (USGS) is an airborne imagery. It has a spatial resolution of approximately one meter/pixel with geoaccuracy of approximately five meters. Current commercial satellite imagery has varying degrees of multi-orbit offset or drift which is greater than the DOQQ offset. For example, DigitalGlobe's WV2 imagery, LV1B, 15SEP25190225-M1BS-055062039010_01_P005 vs. 155EP22190255-M1BS-05506203910_01_P007 in Oakland, Calif. has an offset or drift of magnitude greater than 100 meters. In addition, more recent Skysat imagery in Oakland, Calif. (Oct. 4, 2019) has three sets of offset or drift: (1) the Pan Ortho as high as 186 m, (2) the Analytics as high as 730 m, and (3) the Pansharpened, 24 m.

Spatial mismatch or offset or drift among multi-orbit imagery may be due to dissimilarities in resolution levels, their location or translation, their depression angles, their orientations, inherent satellite GPS pointing error, terrain elevation effects, and combinations of these factors.

Conventional methods of image registration include orthorectification and a number of image warping approaches (for example, nearest neighbor and rubber sheeting methods) as well as variations of these methods. Such methods are known to those of skill in the art.

An orthorectified image has a constant scale over the entire image surface, both vertically and horizontally, as if it were a map. Thus, when all of the input images are orthorectified, each of them has a constant scale, and each column of the image is oriented toward the north. However, there is no standard for an orthorectification algorithm, yielding varying results of orthorectification. For example, ArcGIS software for orthorectification is different from European Monteverdi orthorectification results.

The problem of using orthorectification as a means of rectifying the terrain effect before image registration stems from the fact that orthorectification by itself is a complex process that may violate the scene's spectral integrity with its nearest neighbor, or bilinear, or cubic resampling method. In many cases, it cannot be assumed that orthorectified imagery is a natural product of any particular remote sensing system.

The inventive system thus provides a novel means for (1) orthorectification, (2) automated georegistration (AGR), and (3) reducing drift to zero and 1-pixel for the 95% of the full scene by matching the to-be-aligned imagery to the base with rational polynomial coefficients (RPC) and digital elevation (DEM) data.

Moreover, in general if the base is an orthoimagery, the resulting aligned imagery is inherent with the properties of orthoimagery without the use of RPC and DEM. Such an image georegistration system is a fundamental paradigm shift from a domain of photogrammetry/sensor camera model to a domain of image-to-image alignment. In addition, the inventive automated georegistration and scene alignment is generalizable across varying sensors from satellite/aerial imagery to video imagery.

From a review of the most commonly-used image processing software, such as Earth Resources Data Analysis System (ERDAS) and the Environment for Visualization Images (ENVI), ArcGIS10.3, conventional image registration approaches are centered on interactive, man-in-the- loop method of imagery registration.

In its simplest form, image registration begins with matching selected control points (i.e., pixels). Once the control point pixels are relocated to match the identical control points in another image, the rest of the pixels must somehow be moved to create one or more new images. The rules by which pixels in each image of the to-be-registered images are moved to match the base constitute an image registration algorithm. While computational procedures for image registration are computerized, the steps the image analyst must follow are usually both time-consuming and tedious. While ArcGIS10.3 allows “automated georegistration” after a user manually inputs two sets of imagery, man-in-loop steps like selecting nearest neighbor resampling, and exporting/outputting the newly registered imagery are still required to complete the process of so-called automated georeferencing.

While distinct objects in images from different sources have rich information from different scales, depression angles, and/or orientations, identical geospatial data, multi-orbit, multi-sensor geospatial information is not heavily utilized because those images are rarely georegistered and disseminated to end users. Users themselves must perform both orthorectification and georegistration or georeferencing.

### Description of Related Art

U.S. Pat. No. 7,899,272 for METHOD OF RECOGNIZING AN OBJECT IN AN IMAGE USING MULTI-SENSOR INTEGRATION THROUGH CONDITIONALLY OPTIMAL GEOSCENE GENERATION AND REGISTRATION issued to Hsu on Mar. 1, 2011 discloses a method of recognizing an object in an image using multi-sensor integration through conditionally optimal geo-scene generation and registration. At least two images, one of which is a conditionally optimum, orthorectified base image, are input and used to generate a geoscene using ground control points in a latitude-longitude geospatial domain. Georegistration of the geoscene produces a registered geoimage which may be output. A virtual geospatial information system database may be compiled from the georegistered images. A Virtual Transverse Mercator (VTM) projection is defined which allows processing of images falling on both sides of the equator or across traditional UTM boundaries. The georegistration process utilizes the union and the intersection of image pixels, and geooverlaying with interacting layers including geogrids and text layers, to define main body and background pixels to facilitate object recognition.

U.S. Pat. No. 7,343,051 for METHOD OF RECOGNIZING AN OBJECT IN AN IMAGE USING MULTI-SENSOR INTEGRATION THROUGH CONDITIONALLY OPTIMAL GEOSCENE GENERATION AND REGISTRATION issued to Hsu on Mar. 11, 2008 discloses a method of recognizing an object in an image using multi-sensor integration through conditionally optimal geoscene generation and registration. At least two images, one of which is a conditionally optimum, orthorectified base image, are input and used to generate a geoscene using at least two ground control points in a latitude-longitude geospatial domain. Georegistration of the geoscene produces a registered geoimage which may be output. A virtual geospatial information system database may be compiled from the georegistered images. A virtual transverse Mercator (VTM) projection is defined which allows processing images falling on both sides of the equator or across traditional UTM boundaries. An Affine transform is used for coordinate transformation in generating geoscenes. The georegistration process utilizes the union and the intersection of image pixels, and geolayering with interacting layers including geogrids and text layers, to define main body and background pixels to facilitate object recognition.

U.S. Pat. No. 5,596,500 for MAP READING SYSTEM FOR INDICATING A USER'S POSITION ON A PUBLISHED MAP WITH A GLOBAL POSITION SYSTEM RECEIVER AND A DATABASE issued to Sprague, et al. on Jan. 21, 1997 discloses a combination of a GPS receiver for determining a user's position in terms of latitude and longitude, a database that indexes approximately 53,000 USGS 7.5 minute series topographical quadrangle maps by the latitude and longitude of at least one point on each map, and an interpreter and display that communicates the particular USGS map that represents the user's position together with the ruler dimensions left/right/up/down from a reference point on that map which pinpoints the user's position on the map. The database is stored in the permanent memory of the GPS receiver and the interpreter and display are controlled by a microcomputer included in the GPS receiver. The reference points include sixteen intersections on the map of 2.5 minute intervals of latitude and longitude contained in each 7.5 minute series quadrangle.

### SUMMARY OF THE INVENTION

In accordance with the invention, there is provided a method of recognizing an object in an image in multi-orbit automated georegistration. The procedure uses multi-orbit satellite imagery. At least two images, one of which is typically a conditionally optimal or optimal, orthorectified base image, are used to generate an aligned scene. The aforementioned iMaG Automated Georegistration is a system under a virtual transverse Mercator (VTM) projection that does not alter imagery's DN-values in U.S. Pat. Nos. 7,889,272 and 7,343,051 to minimize distortion in projecting the Earth's 3-D coordinate system to a 2D map projection.

Specifically, the invention is a method of generating a Virtual Geospatial Information System (VGIS) database for recognizing an object in an image. At least two images are input to the system, one of the images being a base image for scene registration. At least one orthoimage is generated with corresponding digital elevation model (DEM) data and rational polynomial coefficients (RPC or RPB) camera model, in a Virtual Earth Coordinate (VEC) System domain. The at least one orthoimage is registered to produce a registered image set. Georegistered imagery with scene content signatures is output for automated scene content analysis and automated change detection. In another embodiment, the method of generating a VGIS database for recognizing an object in an image includes the steps of: inputting at least two images, one of the images being a base image for scene registration; registering the at least one image in the virtual Earth or no-coordinate domain to produce a reduced drift geo-aligned image set; and outputting the geo-aligned imagery comprising at least one item chosen from a set of items consisting of: scene content signatures; signature libraries of the base images and the registered image set; georegistration variance score map; georegistration drift score database; and change detection.

In the present invention, three-way representations of drift data are generated at a tie point or ground control point (gcp) to measure and depict (1) the original drift, (2) iMaG AGR orthorectified drift, and (3) iMaG AGR reduced drift at zero and 1-pixel level for 95% of the full scene in terms of visual, numeric, and cartographic representations. A set of scene content signatures is generated automatically. Subsequently, Automated Change Detection is performed.

### BRIEF DESCRIPTION OF THE DRAWINGS

The file of this patent contains at least one drawing executed in color. Copies of this patent with color drawings will be provided by the Patent and Trademark Office upon request and payment of the necessary fee.

A complete understanding of the present invention may be obtained by reference to the accompanying drawings, when considered in conjunction with the subsequent detailed description, in which:

FIG. 1 depicts an iMaG georegistration system iMaG VTM: three-way conversion;

FIG. 2 is s cross-zone UTM case at Culpeper, Va.;

FIG. 3 is Original WV2 September, 2015 P005 image;

FIG. 4 is DEM for WV2 September, 2015 P005 image;

FIG. 5 is iMaG AGR orthorectified WV2 P005 Image;

FIG. 6 is a comparison of Spectral Digital Number (DN) value change between iMaG AGR orthorectification and ArcGIS orthorectification;

FIG. 7 is the hit-rate of Vehicle Detection Result between the Original WV2 P005 imagery and iMaG AGR Orthoimagery: Hit-rate is 7/7;

FIG. 8 is the hit-rate of vehicle detection result between the original WV2 P005 imagery and ArcGIS orthoimagery, the hit-rate being only 1/7;

FIG. 9 is definite of drift at each of the gcps;

FIG. 10 is drift at the original matching pair;

FIG. 11 is drift at the iMaG AGR orthorectified matching pair;

FIG. 12 is drift at the final iMaG AGR reduced matching pair;

FIG. 13 is an original SkySat Pan Ortho Oct. 4, 2019 visual drift;

FIG. 14 is an original SkySat Analytics Oct. 4, 2019 visual drift, Oakland, Calif.;

FIG. 15 is an original SkySat pansharpened Oct. 4, 2019, visual drift, Oakland, Calif.;

FIG. 16 is Mountain Drift from DOQQ vs WV2 Sep. 22, 2019, P007;

FIG. 17 is Hilly Drift from DOQQ vs. WV2 Sep. 22, 2019, P007;

FIG. 18 is Urban Drift from DOQQ vs. WV2 Sep. 22, 2019, P007;

FIG. 19 is scene content signatures/layers from QBjan05, FL;

FIG. 20 is scene content signatures/layers from Bmay06, FL;

FIG. 21 depicts change detection comparison: ArcGIS10.2 vs. Metadata vs. iMaG AGR overview from QBjan05, FL vs. QBmay06, FL scene content signatures;

FIG. 22 depicts iMaG automated change detection closeup: QB05jan vs. QB06may, FL;

FIG. 23 depicts iMaG AGR graphic user interface (GUI) showing iMaG uses ranked scene content signature to define change detection;

FIG. 24 depicts iMaG AGR applies spatial descriptors to change detection; and

FIG. 25 depicts an iMaG AGR system workflow model.

### DETAILED DESCRIPTION OF THE PREFERRED EMBODIMENT

According to U.S. Pat. Nos. 7,899,272 and 7,343,051, a geoscene is defined in terms of an image in which every pixel is denoted by five or six locational identification systems:
a) (x,y) coordinates in the image domain;
b) (z0) coordinate for terrain elevation and/or (z1) coordinate for spectral/elevation data;
c) UTM or VTM coordinates in the map projection domain;
d) decimal degree in the geospatial domain; and
e) degrees, minutes and seconds in the geospatial domain.

Several tools exist to perform conversions between or among various coordinate systems. First, a bi-directional method for conversion between lat-long and UTM is required. Basic methods for two-way lat-long to UTM conversions are provided in Wolf and Ghilani, Elementary Surveying: An Introduction to Geomatics (New York: Prentice Hall, 2002). However, a superior method of performing such conversions is provided by U.S. Pat. Nos. 7,899,272 and 7,343,051.

In the UTM system, the geographic location of each zone is fixed. Consequently, the central meridian at the center of each UTM zone has a fixed location. In accordance with the U.S. Pat. Nos. 7,899,272 and 7,343,051, the location of each VTM zone is movable. The width and height of a VTM zone may be the same as those of a UTM zone. In other words, by moving a 6×8 degrees area, all the pixels of the images to be registered are then moved so as to be included within one particular VTM zone. This means that for all the pixels within the VTM zone, there is only one central meridian for orientation designation. The local central meridian may be determined by the distribution of the locations of the pixels under investigation. The specification for the location meridian is as follows.

For a particular VTM zone to exist, all of the locations of the pixels covered by the images to be registered are geolocated. From the min and max lat-long readings of the locations of the pixels, the local central meridian is determined; from that central meridian, a particular VTM zone is generated. Thus, the specifications for the local VTM meridian are as follows:
a) the local meridian is the mean of all locations of the pixels under investigation; and
b) the local central meridian is designated by an integer (i.e., a whole, rounded number), for example 77 degrees.

In the UTM system, the distance designation in the longitude direction is divided into northern hemisphere and southern hemisphere, independently. Because each hemisphere starts at 0 and ends at 10 million meters, the UTM system cannot handle images having pixels dispersed over both north and south of the equator. In the VTM specification, however, both the northern hemisphere and the southern hemisphere are treated as one contiguous entity.

Mathematically speaking, locations in the northern hemisphere are treated as positive numbers, while locations in the southern hemisphere as treated as negative numbers. Therefore, a third VTM specification is:
c) longitude readings in the northern hemisphere range from 0 to 10 million meters; and longitude readings in the 15 southern hemisphere range from 0 to negative 10 million meters.

The mathematics that form the basis of the novel VTM system may be obtained from Wolf and Ghilani, identified hereinabove.

To transform between two coordinate systems, the Affine transform is used. The mathematics for the Affine transform appears in the above-noted reference.

Four models for geoscene generation are used as part of previously-cited patents and utilize a different set of assumptions.

For geoscene generation, it is assumed that a conditionally optimal base image (COBI) or optimal base exists, and other scenes are to be georegistered onto the COBI. A high resolution orthophoto with known geo-coordinates for a few pixels known as the ground control point (gcp) is an example of a COBI.

To generate a geoscene, an executable script that contains four sets of arguments is used:

Program Name-in infile_name-out outfile_name-ref“utm

coordinate@x,y)-ref“utm coordinates@x,y)-ref“utm

coordinate@x,y)-ref“utm coordinate@x,y) (Eq. 1)

The number of -ref controls how many ground control points are used to generate the geoscene.
/*-ref twice for two control points*//*
/*-ref four times for four control points*/From Equation (1), out file is a geoscene.

In addition, the ground control points must have both geo-coordinate readings, and visually distinct features for manual pointing. A Graphic User Interface (GUI) counterpart for the above discussed script file based geoimage generation is also provided by the above-referenced U.S. patents. When a geoimage cannot be generated, the VTM system reverts to a Virtual Earth Coordinate (VEC) system until ground control points become assignable in the real Earth Coordinate System. It means that the above “geo” prefix is changed to “virtual” prefix until it can be changed back to “geo” prefix. Therefore, for the present invention, “geo” and “virtual” are interchangeable.

It should also be noted that the number of control points used determines whether the solution is unique or based on a least square model.

Once the COBI is an oblique image, its base coordinate system may follow any of the mathematically-based coordinate transforms like Affine or the one that handles the tilt factor.

Under the mathematical VTM system, an arbitrary coordinate or Virtual Earth Coordinate (VEC) system is assigned for it to work as a bona fide coordinate system based image.

From the foregoing, it may be understood that the end product of georegistration, real or virtual, has the same resolution. The x-scale and the y-scale of the pixel, and the orientation of the matched images are almost identical to those characteristics of the COBI. Therefore, if the COBI is an orthoimagery, the matched images become an imagery that possesses orthoimage properties.

While the iMaG Automated Georegistration (AGR) system is capable of generating near-orthoimagery without having to possess the camera models of the sensors, RPB, and digital elevation model (DEM) of the image coverage area, it is better to possess a bona fide orthorectified imagery for iMaG AGR automated georegistration. Since there is no standard of an algorithm for orthorectification, a novel orthorectification method is herein invented by incorporating both RPC or RPB camera model and DEM under above noted VTM system that preserves the spectral integrity of the scene.

On a flat map, one of the most commonly used counterparts of the lat-long system is the map-based Universal Transverse Mercator (UTM) projection that denotes a particular location using “easting” (in meters) and “northing” (in meters) plus a zone ID. Each UTM zone is defined by six degrees in easting and eight degrees in northing. One degree represents approximately 110,000 meters.

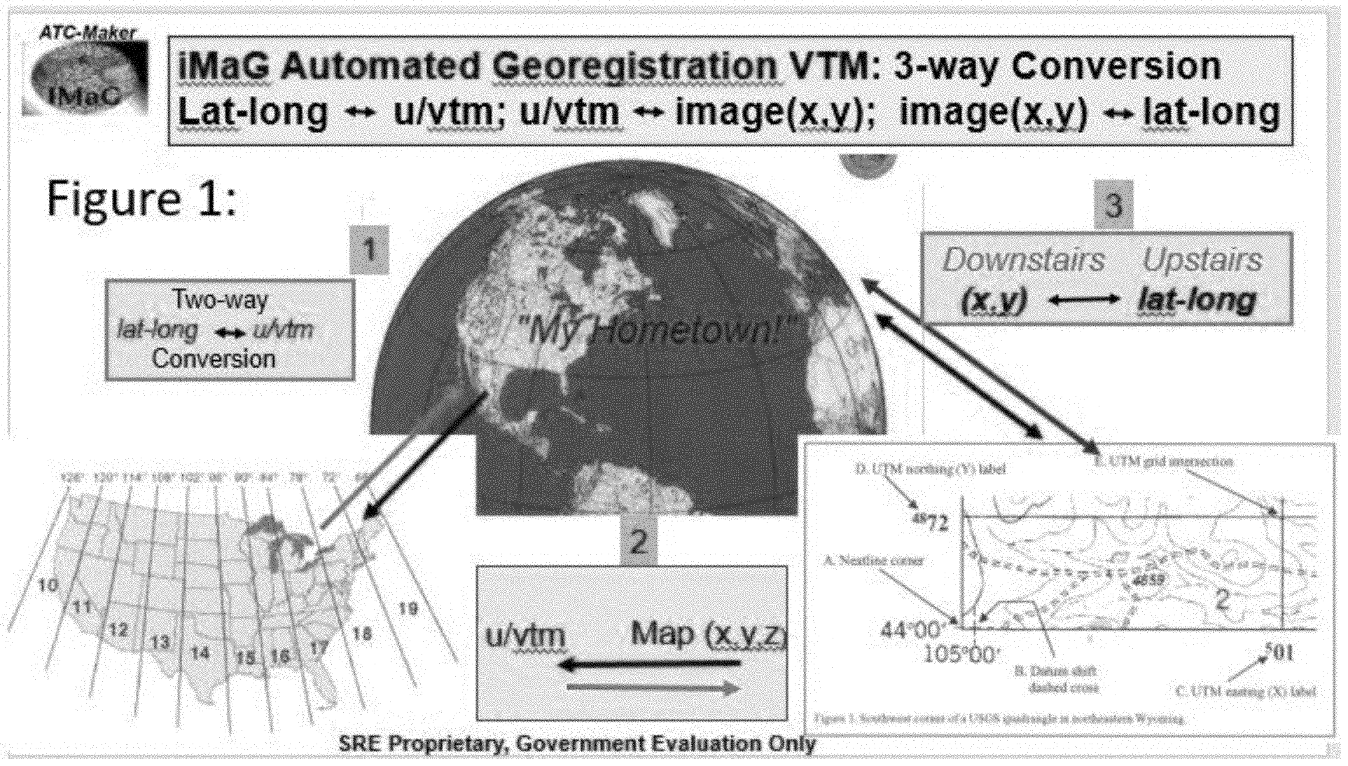

FIG. 1 illustrates the iMaG automated georegistration with three-way conversations: (1) lat-long to image, (2) image to (x,y), and (3) (x,y) to lat-long coordinates. The assignee's VTM system is a generalization of a conventional UTM system that was awarded U.S. Patent No. 7,343,051.

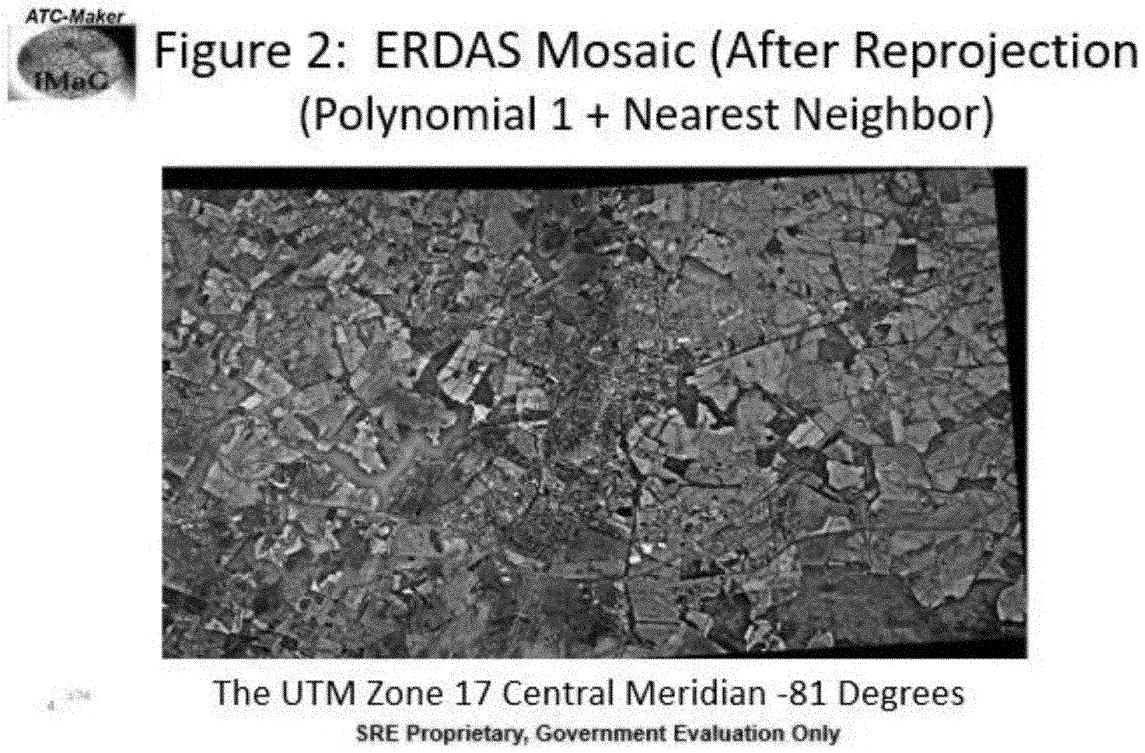

This zone ID-based UTM system works well for point locations since one-point location can be easily identified within one particular UTM zone. In an image that covers a large geographic area, the image pixels may fall into two different UTM zones. A case in point is the city of Culpepper, Va., (FIG. 2) which falls into two UTM zones. That is, East Culpepper DOQQ belongs to UTM zone 18, whereas West Culpepper DOQQ belongs to UTM zone 17. Since the central meridian for UTM zone 17 is different from the central meridian of zone 18, there is a mismatch between the West Culpepper DOQ and the East Culpepper DOQ at the junction of these two DOQs. This mismatch occurs in the center of the city. FIG. 2 shows the mismatch pattern at the junction of two UTM zones is eliminated by the patented VTM based geomosaic.

In this cross-zone scenario, the mathematics used for the conventional UTM system may be inadequate to deal with the pixels in one image, which spans two UTM zones. Similarly, UTM has difficulty dealing with image pixels that are dispersed into both north side and south side of the equator.

For the case when a geoimage cannot be generated, images are used from a video system to illustrate object tracking without a coordinate system under the fundamental mathematics of the VTM system in U.S. Pat. No. 7,343,051.

Therefore, it is advantageous to define a projection system according to a virtual Earth, from which an image processes a virtual Earth coordinate system (VEC) developable from the aforementioned VTM system.

It is also advantageous to revert the VEC system to the VTM system when ground control points can be tied to the real Earth's coordinate system (i.e., in the latitude-longitude domain).

It is also advantageous to object link and track without a coordinate system with overlapping scenes like video images to generate a Virtual Image Registration (VIR) system.

It is definitely advantageous to measure and depict the original offset or drift between a pair of multi-orbit imagery. One of the pair can be a base, and the other to-be-aligned. The measure can be the distributional characteristics of the drift data.

It is absolutely advantageous to orthorectify the scene to rectify the terrain elevation effect.

Since currently no standard exists for an orthorectification algorithm, it is advantageous to invent one that is capable of rectifying terrain elevation at the same time preserving the spectral integrity of the scene at much as possible.

The current inventive system offers a novel approach to align and georegister them using an Automated Georegistration (AGR) system that permits the use of a massive amount of tie points or ground control points (gcps) to partition the full scene into virtual tile cells and match at the gcp pixel level.

With the novel iMaG AGR orthorectification system, it is also advantageous to measure and depict the resultant orthorectified drift data by a statistical method, comparable to the one for measuring the original drift data before orthorectification.

It is therefore advantageous to perform automated georegistration as a follow-on procedure in virtual image registration (VIR) domain in which objects in neighboring and overlapping scenes are linked and tracked.

In certain conditions, even if both base image and to-be-registered image are geoimages, the “camera models” are so incompatible that they cannot be aligned well within a reasonable level of geoaccuracy using a mathematically based coordinate transform model.

It is definitely advantageous to reduce the drift at each gcp to zero for the 50% or more of the full scene.

It is even more advantageous to reduce the none-zero gcp to 1-pixel level up to the 95% or more for the full scene. The remaining few percentage <5% are called “others” that can be the real difference for change detection.

It is more advantageous to depict the drift data in three-way representations: (1) visual for a better communication, (2) automated numeric for scientific analysis, and (3) cartographic or choropleth method for generalizing the numeric drift data.

Since the cadastral survey at the household level is the most accurate lat-long data in the U.S., it is definitely advantageous to use them as gcps to generate a base imagery at the geo-accuracy level better than the current DOQ or DOQQ.

Since the cadastral survey lat-long data are not available in non-U.S. areas, it is advantageous to correlate the cadastral data with the best of imagery data in the U.S. for the prediction of an object's lat-long with the modeled imagery data in the non-U.S. area.

It is more advantageous to use 30 or more imagery to correlate against the cadastral survey data at three terrain types: (1) mountain, (2) hilly, and (3) urban.

It is definitely advantageous to use varying sizes of image tiles so that generic scene matching can be achieved at a certain robustness level.

Therefore, it is advantageous to define a way to measure and evaluate the offset between a pair of matched region with a gcp.

By the same principle, it is advantageous to define, map, and output the difference between the base and the to-be-aligned or the aligned image; the less the difference, the higher the possibility of success the matching analysis.

It is also advantageous to perform regular georegistration between the base and the aligned to delimit the spatial domain for automated georegistration to visualize the original offset or drift.

Therefore, it is also advantageous to convert a given scene into a geoscene for georegistration consistent with U.S. Pat. Nos. 7,899,272 and 7,343,051, a pixel in a geoscene having quintuple representations:
(1) (x,y) coordinates in the image domain;
(2) (z) coordinate in the spectral and/or elevation/height domains;
(3) UTM representation in the geospatial domain;
(4) latitude-longitude in the geospatial domain; and
(5) Virtual Transverse Mercator (VTM) representation in the geospatial domain.

It is equally advantageous to convert a given scene into a virtual Earth scene when it cannot be converted to a geoimage. In the method of the present invention, a pixel in a virtual Earth system has quintuple representations:
(1) (x,y) coordinates in the image domain;
(2) (z) coordinate in the spectral and/or elevation/height domains;
(3) UTM representation in the geospatial domain;
(4) latitude-longitude in the geospatial domain; and
(5) Virtual Earth Coordinate (VEC) representation in the virtual-spatial domain.

It is therefore advantageous to have the VTM system as a part of the VEC system when the ground control points are assignable in the real geo-coordinate domain.

UTM is a map-based representation of latitude and longitude (lat-long) readings. Conversion between lat-long and the UTM system may be obtained using the methods outlined in Wolf and Ghilani, Elementary Surveying: An Introduction To Geomatics (Prentice Hall, 2002). Using the geoscene in accordance with the present invention, pixel (x,y) readings may be converted to UTM or the lat-long equivalent freely in both directions. This means that the distance between two pixels in the geoscene may be measured in terms of the physical distance in meters on the ground.

Since image pixels may be distributed over multiple UTM zones and/or over both the north and south sides of the equator, it is advantageous to develop a modified UTM system by which the central meridian may be adjusted according to the spatial locations of the pixels instead of fixed locations. Also, the northing readings may be calculated across the equator in a continuous fashion. In the present invention, this is referred to as a Virtual Transverse Mercator (VTM) projection.

It is also advantageous to measure the resolution of a pixel in an image in terms of both x and y axes, or easting and northing in the context of both the UTM and the VTM systems. In the ortho-photo case, the x-resolution equals the y-resolution. In non-ortho-photo cases, however, the x-resolution does not equal the y-resolution.

It is advantageous to perform Automated Georegistration in the VTM domain to minimize distortion under map projection from the lat-long domain to the x, y domain.

In addition to having the VTM system, it is advantageous for the iMaG Automated Georegistration (AGR) system to have flexible preprocessing means to achieve a successful image data matching, such as various image transforms, and filters.

In addition to image transforms/filters, it is advantageous for the iMaG Automated Georegistration (AGR) system to have flexible matching tie point structures, such as a top-down approach, a bottom-up approach, a multi-layer attach, a sticker matching, or a more relaxed matching, such as a function of image resolutions, image overlaps, communication among resolutions, direction and rate of communication.

In addition to the above vertical communication approach, it is advantageous for iMaG AGR to achieve alignment by horizontal information integration, such as using various texture size and various grid sizes that are parameter controlled by the user.

For regions where tie points are difficult to obtain, it is advantageous to “fill” them by triangulation commonly deployed in ground surveying, or repeat pixels beyond the image border by a certain level of extension.

Once a pair of multi-orbit satellite imagery is automatically georegistered, it is advantageous to automatically generate a set of scene content signatures with corresponding terrain layers.

Once a set of scene signatures is automatically generated, it is advantageous to perform automated change detection and generate a set of change detection maps.

For an automated scene content signatures generator, it is advantageous to have flexibility to set the number of scene content signatures by a degree of duplication parameter.

It is also advantageous to set the maximum number of scene content signatures with an automated stopping means under a set of stopping criteria, such as maximum level of correlation between to closest layers, and maximum number of iterations with user-controllable parameters.

For an automated scene content signatures generator, it is advantageous to have flexibility to generate additional signatures with given prior-generated signatures with user controllable parameters.

It is more advantageous for the automated scene content signature generator to generate other categories to complement the original specified number of signatures. For example, one can specify 10 signatures at the original set, and can specify to grow sets of three other signatures iteratively up the final set of 25 signatures. The iteration process following the following format: 10+3+3+3+3+3=25 a total of seven iterations of growing signatures.

It is equally advantageous for automated scene content signatures/layers generated for each pixel to possess its likelihood of association with each of the scene content signatures and represented by a raster image.

For change detection, it is advantageous to perform automated change detection in addition to interactive change detection.

For change detection, it is advantageous to provide a means to measure the goodness of fit between a pair of scene content signatures between time 1 scene and time 2 scene in a confusion matrix format.

For automated change detection, it is equally advantageous to define automated change detection in term of the mapping the difference of each pixel's likelihood of association with each of the scene content signatures.

For automated change detection, it is also advantageous to define the mapping change detection from varying degrees of spatial resolution by grid size, such as 1-by-1, 3-by-3, 10-by-10, etc.

Subsequently, it is more advantageous to define the change in terms of the difference in ranked spectral components of scene content signatures between Time_1 and Time_2 at the identical spatial base.

Since there is significant different between metadata based offsets and the iMaG AGR based offsets, it equally advantageous to contrast the Change Detection results between them in terms of the accuracy of change detection as a function of input data pairs, such as metadata vs iMaG AGR.

Orthorectification is designed to rectify the terrain elevation effect inherent in the original image with the DEM. In reality, DEM is also an image with ortho-image, lat-long, coded pixels. Therefore, DEM is a bona fide ortho-image. Since the iMaG AGR orthorectification places the original image onto the DEM image, pixel by pixel, the transferred-onto-DEM image becomes iMaG AGR orthorectified image.

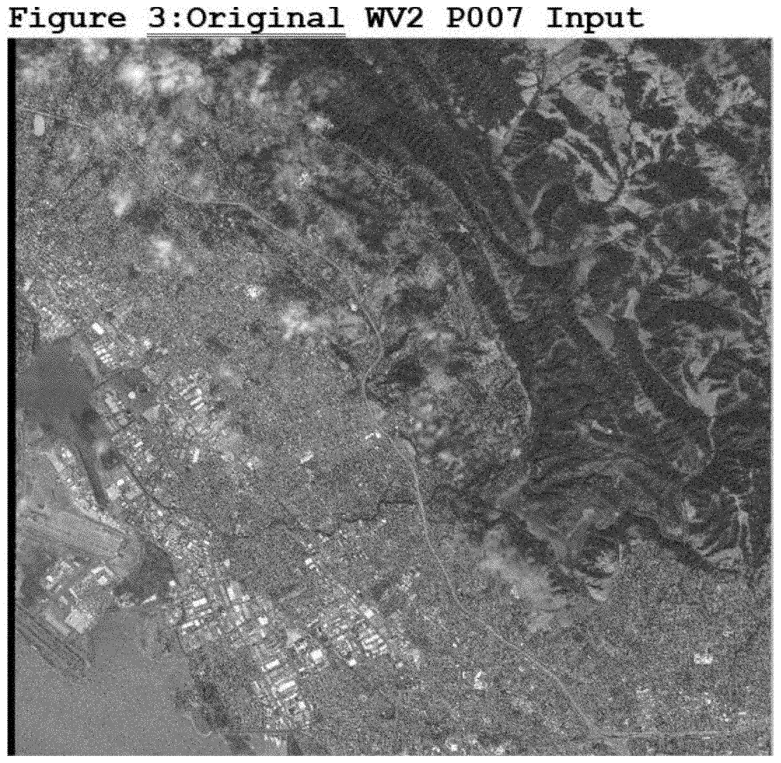

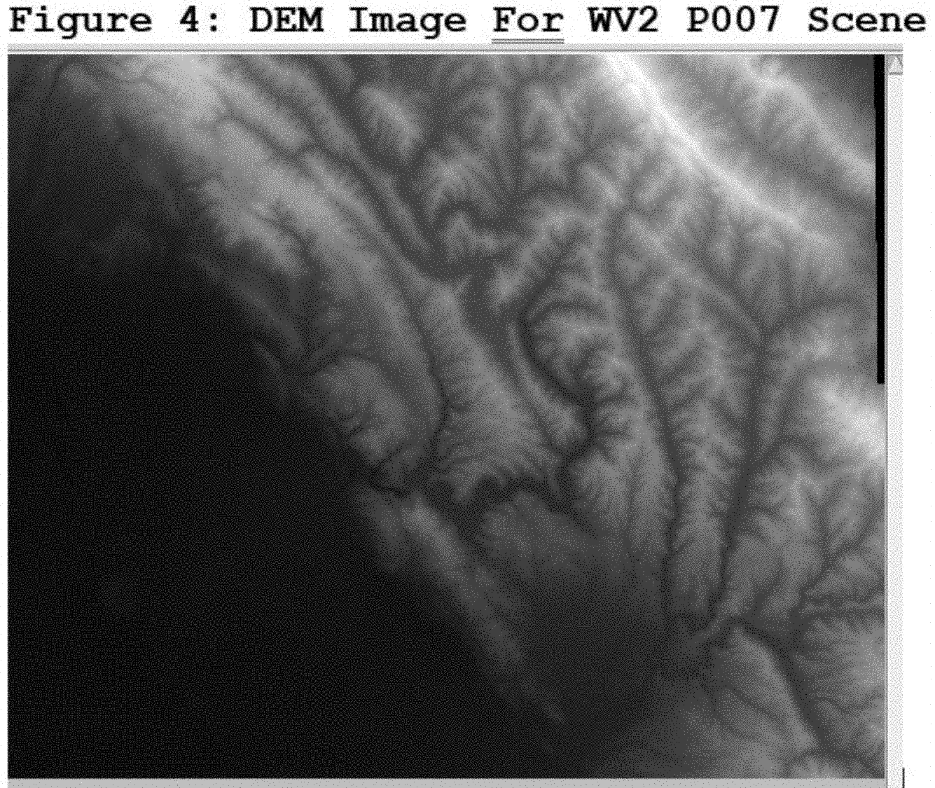

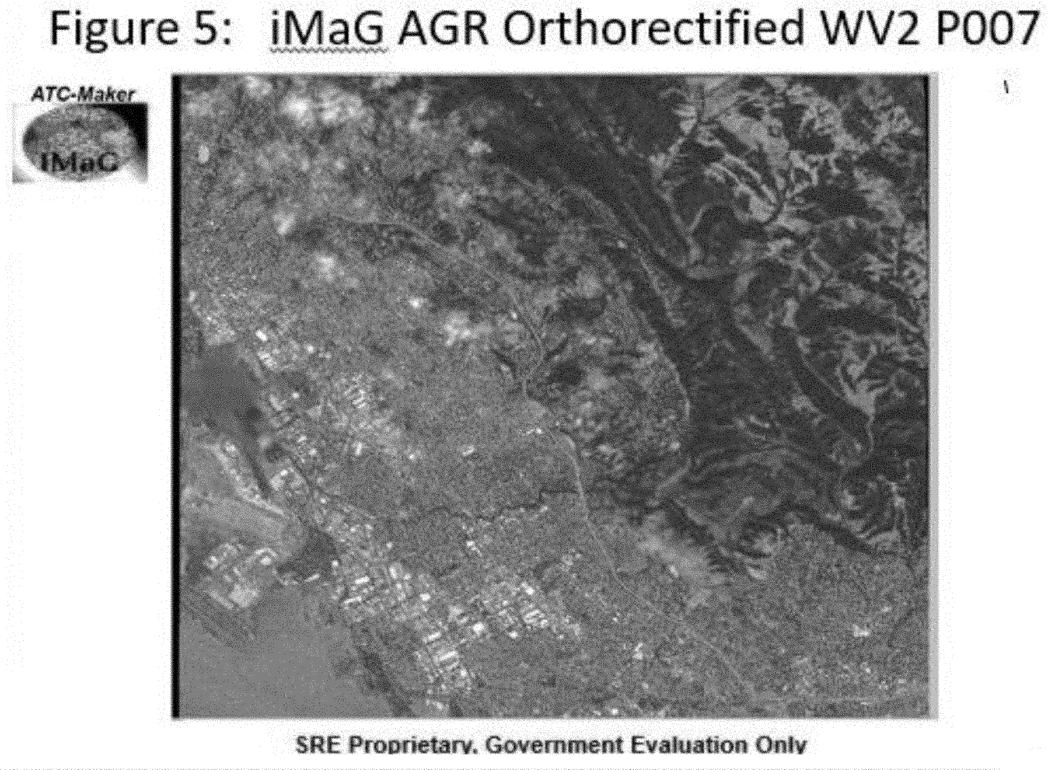

FIG. 3 is the original WV2 Sep. 25, 2015 P005 image; FIG. 4 is the corresponding DEM image; and FIG. 5 the resultant novel iMaG AGR orthorectified WV2 P005 image.

Since iMaG AGR orthorectification is executed under its own patented Virtual Earth Coordinate (VEC) or VTM system U.S. Pat. Nos. 7,899,272 and 7,343,051, the resultant orthoimage's spectral values are directly transferred from the original image domain to the orthoimage domain without a resampling process, such as nearest neighbor, or bilinear, or cubic convolution used in conventional orthorectification algorithms.

However, there is a necessary step that must be performed to accommodate the change of image dimension from the original input scene to the resultant iMaG AGR orthoimage. That is, under the no-resample principle, the original input image is made to fit the dimension of the iMaG AGR orthoimage by reusing the original pixels plus a minimal necessary use of duplicating and dropping the original pixels. Such a minimal amount of dimensional change is usually at the level of less than 3 percent maximum, and less than 0.3 percent minimum. This level of “necessary step” change is much less than conventional nearest resampling methods ranging from 10% to 30%. For example, the original WV2 P005 scene, similar to FIG. 3, was used. The P007 scene acquired three days apart to generate two orthoimages: (1) by conventional ArcGIS orthorectification created by Scott Carter of Creative Map Solutions as an independent third party, and (2) iMaG AGR orthorectification created by Dr. Shin-yi Hsu, one of the current patent applicants.

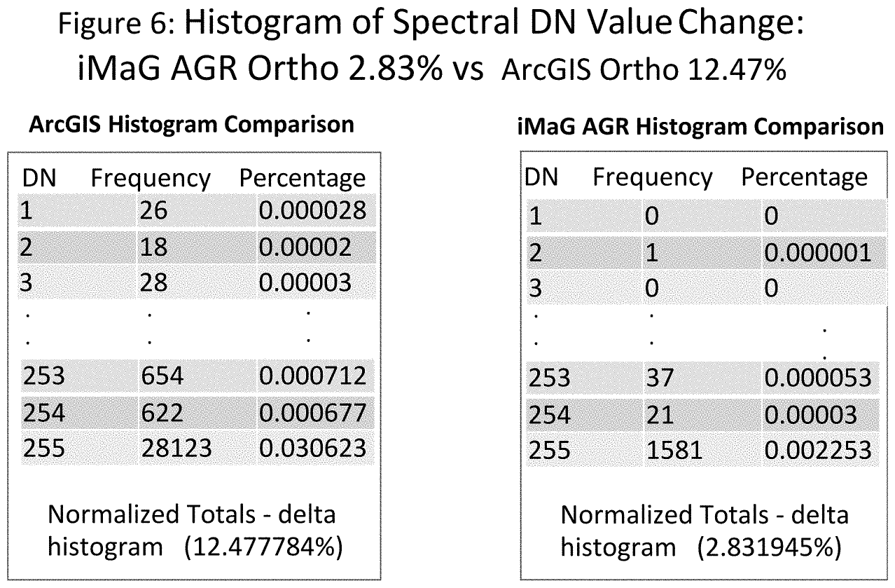

The comparison of the amount of spectral pixel value change is created by a histogram of change for all pixel values, ranging from 0 to 255 as shown in FIG. 6. The right column of FIG. 6 is the amount of pixel shift of 2.83% by iMaG AGR and the left column of the amount of spectral DN value change of 21.9% from ArcGIS orthorectification algorithm.

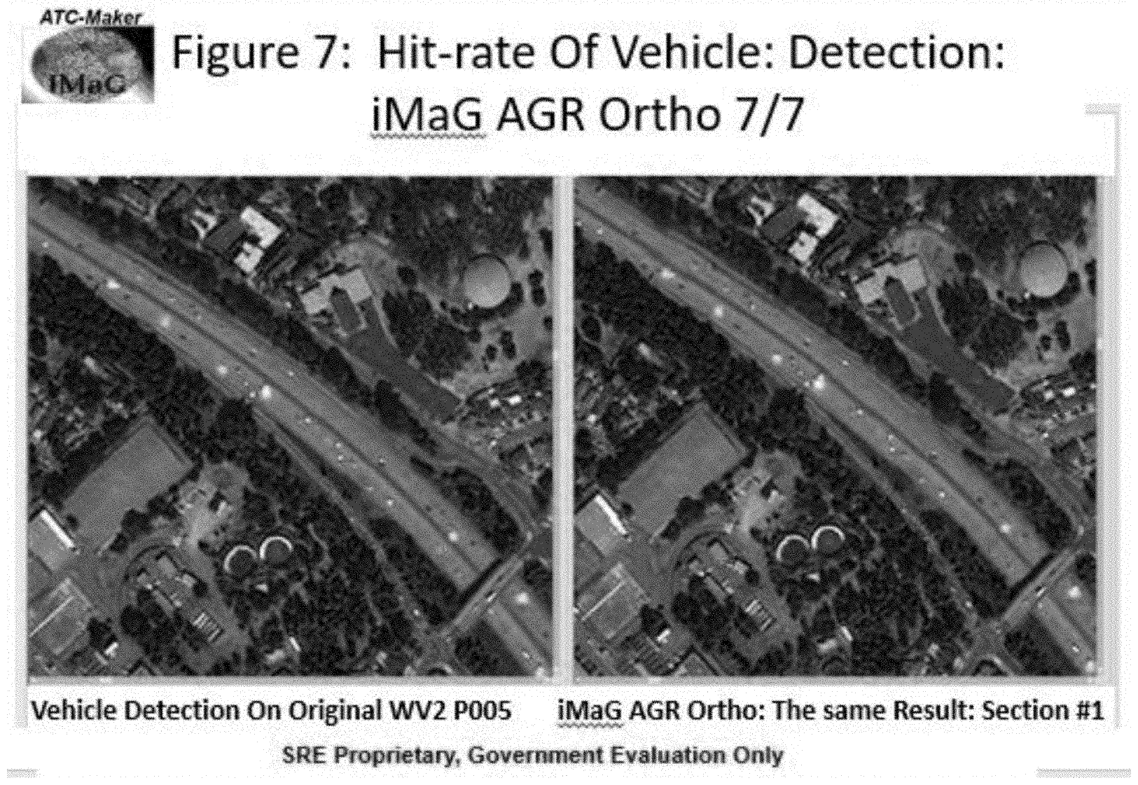

An analysis was performed of the effect of such a spectral value change on detection of ground vehicle using the spectral signatures extracted from the original WV2 p007 scene, and applying them to both the iMaG AGR orthoimagery, and the ArcGIS orthoimagery. The result reveals that there is no difference between detection in the Original WV2 P007 set and its counterpart of iMaG AGR orthoimagery as shown in FIG. 7, one of the total seven test sections.

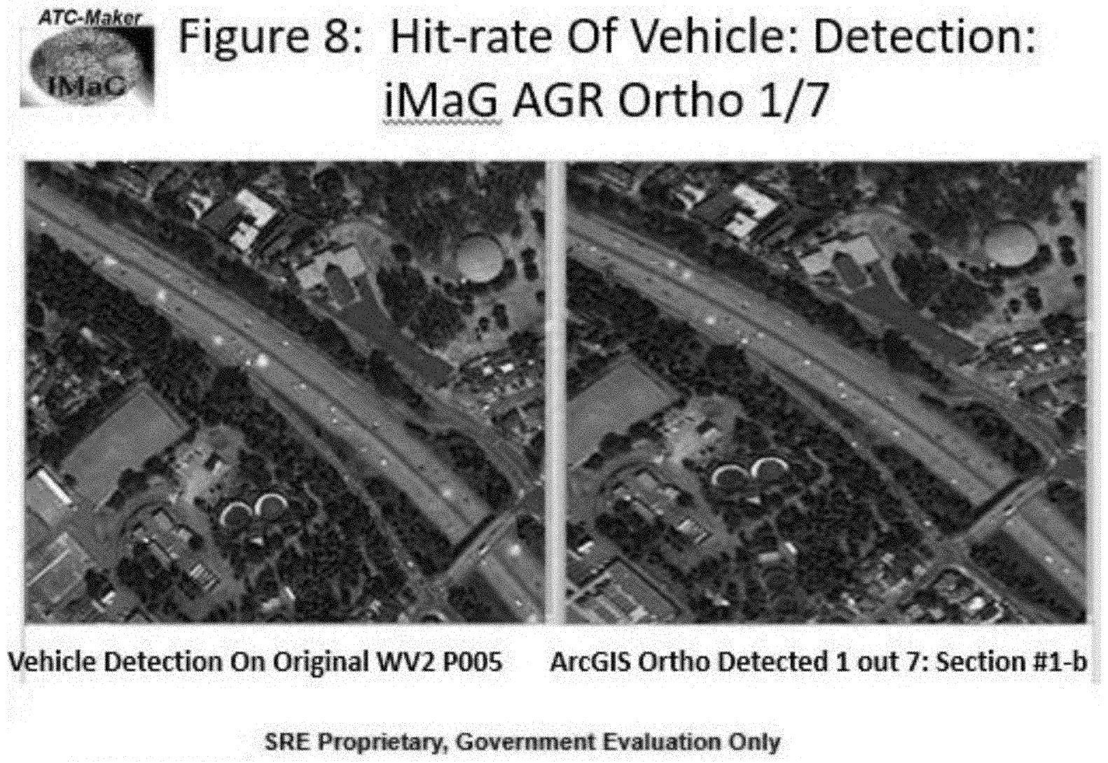

On FIG. 8, detection test results are shown by ArcGIS ortho that detected only 1 out of 7. Such a drastic difference in vehicle detection is significant in favor of the iMaG AGR orthorectification.

In U.S. Pat. Nos. 7,899,272 and 7,343,051, DOQQ was used as the base with the geospatial accuracy of approximately 5 m, and was labeled as conditional optimal.

For this current invention, a cadastral survey lat-long data is used to improve the imagery's geoaccuracy since such a cadastral survey data are legally and the best in the United States. Simply stated the DOQQ data is now replaced by cadastral survey as the ground control points (gcps).

For non-U.S. areas, the current invention uses the best of satellite imagery to correlate against the cadastral survey data in three terrain types: mountain, hilly, and urban. With a cluster of imagery data to correlate cadastral data, a prediction model can be achieved for non-U.S. areas where cadastral survey data are unavailable. Thus, building an optimal base image for the iMaG AGR to reduce drift data to approaching zero is another invention incorporated in this patent application.

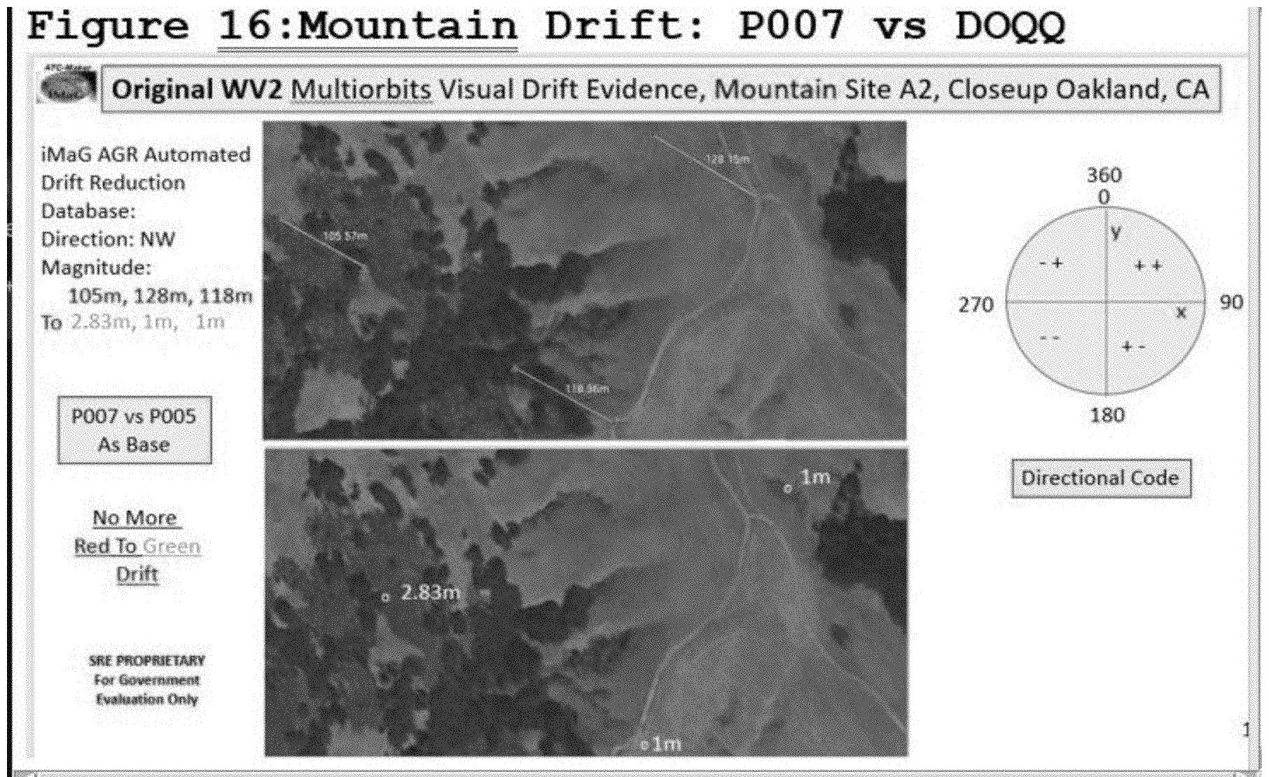

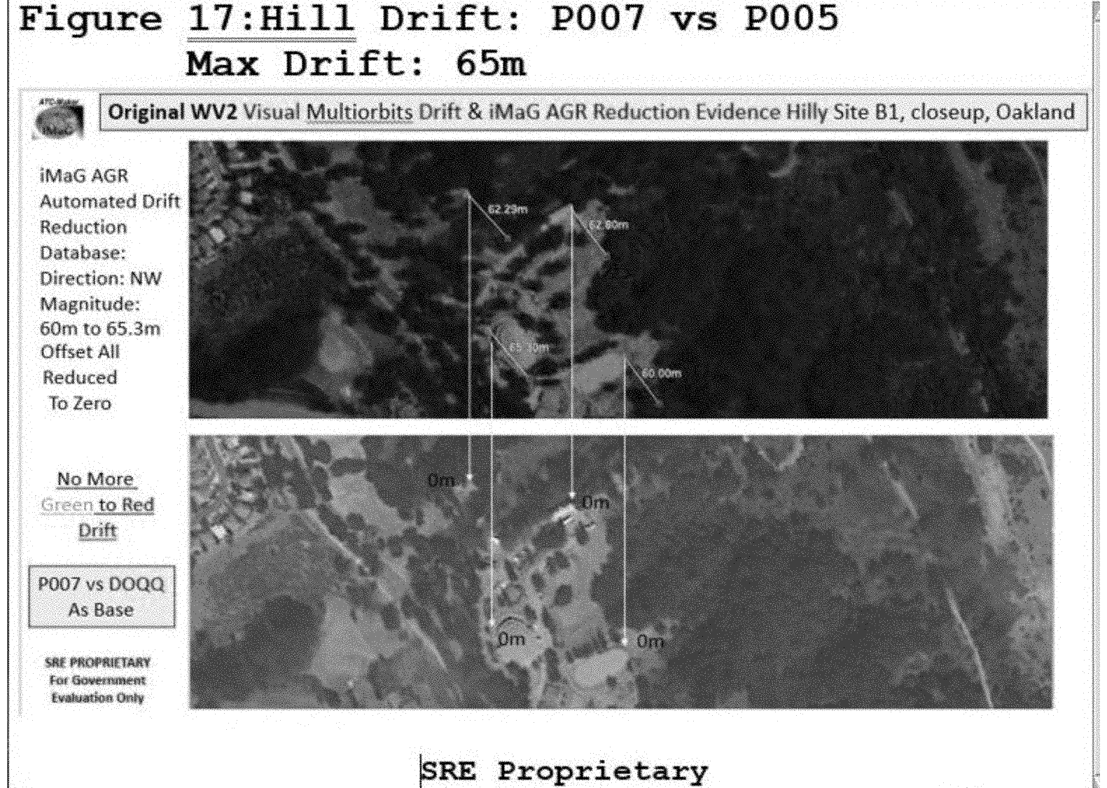

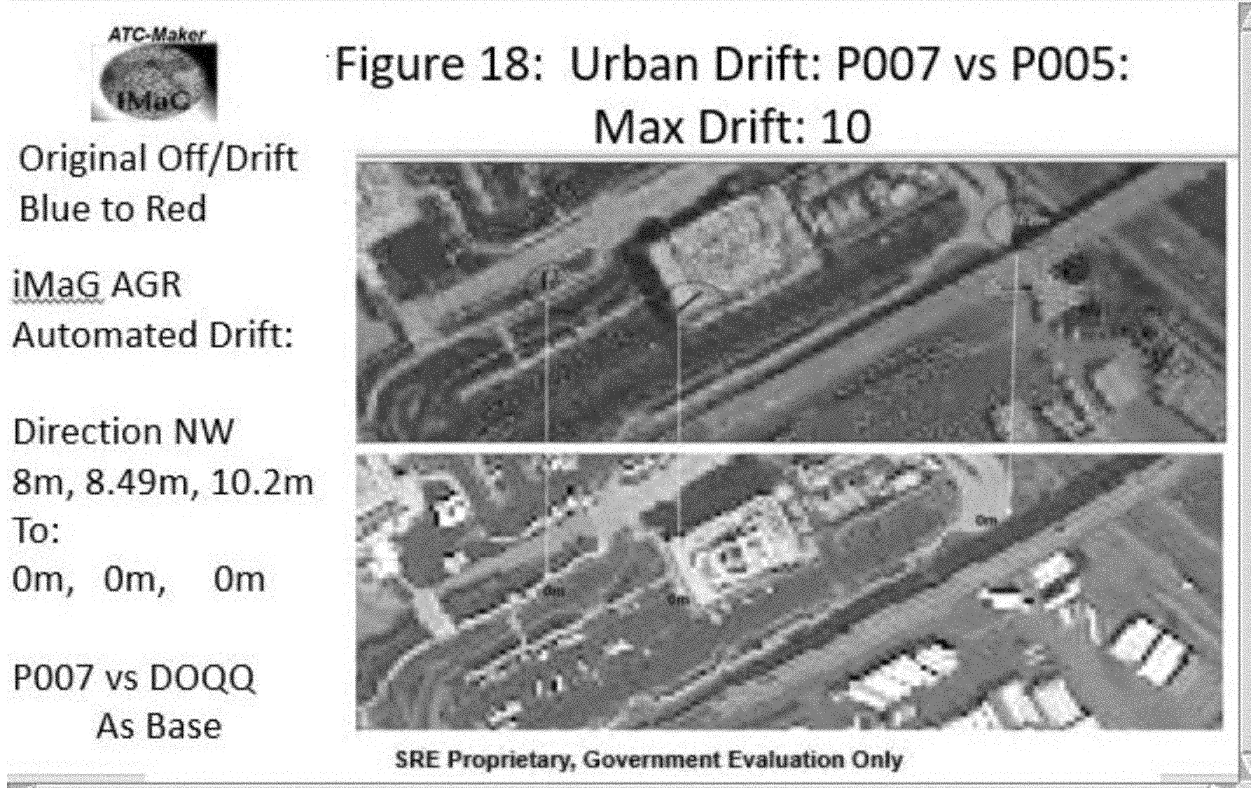

Since drift data are highly affected by terrain types, the mountain drift is shown in FIG. 16; the hilly drift in FIG. 17; and finally the urban drift in FIG. 18.

In this multi-terrain mode, the use varying image sizes x and y dimensions are herein presented, such 1k by 1k, or 2x by 2x or 3k by 3k, etc. to go against the optimal base. This dissimilar size-based matching mode allows the current invention to accommodate multi-sensor, multi-orbit, and multi-temporal matching.

For the present invention, the input imagery is orthorectified and is more appropriately defined by the matching pair as a whole that minimizes the difference between the base and the aligned. The proposed methods include but are not limited to:
(1) scene histogram generation to measure the original input scene difference, like the frequency difference of each graytone value, and the sum of all differences in 255 graytone values;
(2) a logarithm transform of the input scenes;
(3) 2-scene based histogram equalization transform;
(4) optionally to use the raw data without a transform;
(5) combining multiple transforms;
(6) optionally selecting different spectral bands for matching, one from the base, and the other from the aligned; and
(7) georegistration methods as a pre-processing means to fine-tune the spatial base of iMaG AGR.

To output georegistration results, the inventive system assembles the matched pairs together to form one whole scene. In this regard, an optimal base defines the aligned geoimage, i.e., the coordinate system of the original base image is the coordinate system of the resultant matched image pair. In addition, the output is a set of multispectral images.

For iMaG AGR, the inventive system provides a means to generate a set of matching tie-points with the following properties:
(1) a means to preprocess, prioritize matching inputs, the base and the aligned, input pairs;
(2) means to reject or accept to proceed an iMaG AGR analysis;
(3) means to measure and visualize the goodness of matching, offset, by a geo-ruler at selected distinct ground features;
(4) means to generate the number of matching tie points on a need basis;
(5) means to evaluate each pair of a matched tie point;
(6) means to eliminate a “bad” tie-point;
(7) means to project and create a “good” tie points, such as by triangulation;
(8) means to restrict and relax tie-point selection requirements;
(9) means to provide a flexible matching tie-point structure;
(10) means to perform Automated Georegistration by sub-scenes;
(11) means to assemble the results of Automated Georegistration by subsets to form and restore the original full scene;
(12) means to evaluate the goodness of Automated Georegistration matching analysis;
(13) means to implement various iMaG AGR System Architectures and platforms;
(14) means to use non-orthoimage, orthoimagery, gcp-restructured imagery for the base and the aligned imagery;
(15) means to maintain spatial and spectral integrity of the base and the aligned imagery; and
(16) a means to reduce the drift to zero meters.

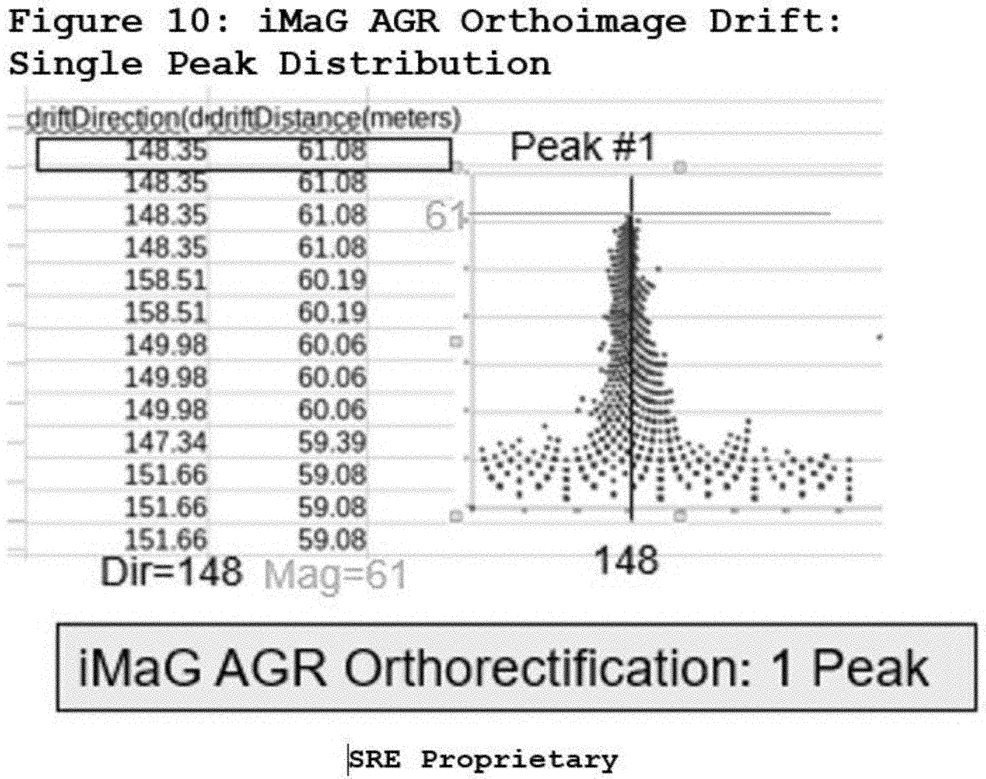

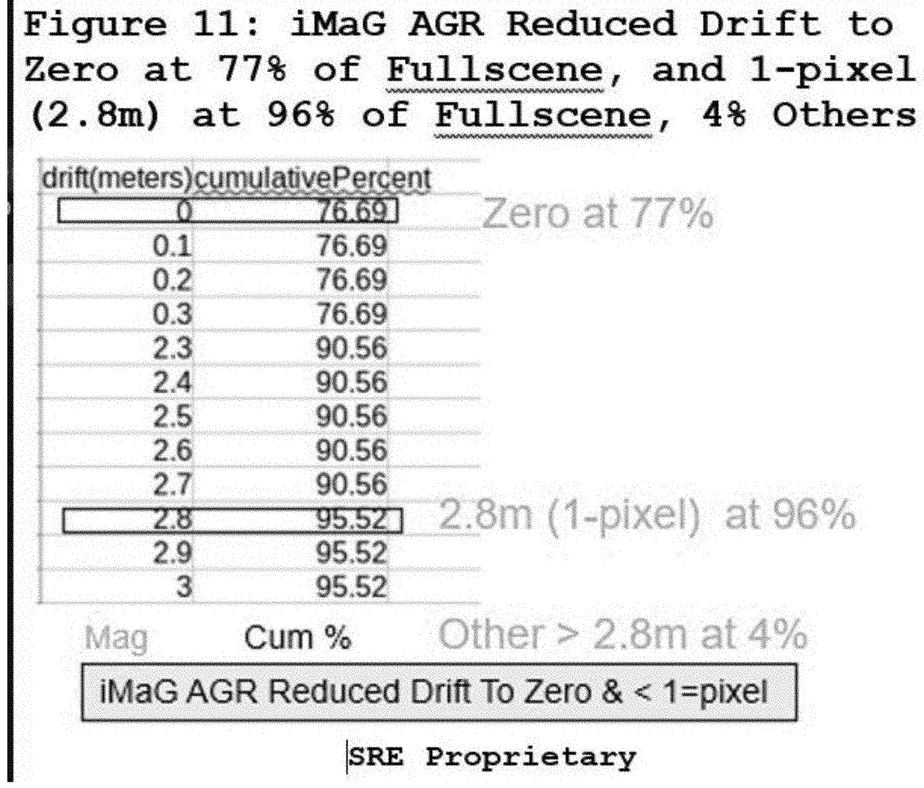

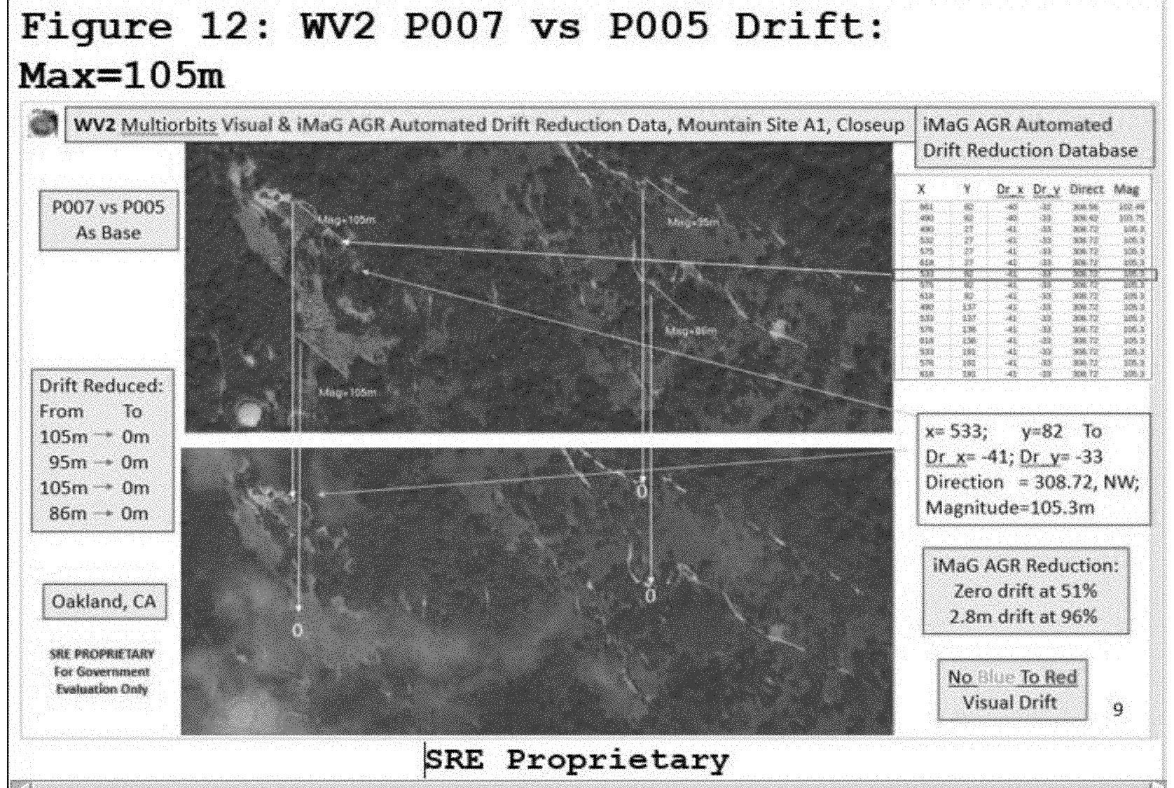

Particularly, the offset or drift is defined at each of the tie point, or ground control point (gcp) by a distance from the original overlay point to the final match point. There are three kinds of drift: (1) drift at the original imagery matching pair (FIG. 10); (2) drift at the orthorectified imagery matching pair (FIGS. 11); and (3) the final iMaG AGR reduced drift matching pair (FIG. 12). The goal of the iMaG AGR automated georegistration is to reduce the drift to zero or under 1-pixel level or others.

The novel Automated Georegistration method of geoscene generation, and georegistration of images from multi-orbit satellite imagery discussed above may be implemented in multi-platforms, such as Linux and Windows, using text-based scripts as well as interactive systems having corresponding graphic user interfaces (GUIs). Both implementations are described hereinbelow. In addition, it will be recognized that the method of the invention may be implemented in firmware using either graphical or text-based user interfaces.

In the GUI-based georegistration or scene alignment system, multiple image viewers or windows are provided. In each image viewer, basic image visualization functions (e.g., zooming, roaming, scale change, pixel intensity change/modification, scene-based gamma functions, real-time goodness-of-match display, 3-D and 4-D viewing in the geospatial domain, etc.) are provided to facilitate the selection of ground control points. One GUI-based implementation of the method of the present invention is the IMaG ATC-Maker system used herein for purposes of disclosure. With GUI-based georegistration systems (e.g., iMaG), once the ground control points are manually or semi-automatically selected, geoscene generation, georegistration, geomosaicking, geomasking, geodropping, and geo-3D or 4D visualization, geocontour, geocontour interval, and geo-flythrough are then automatically executed.

In the process of automated georegistration, the camera model data of the input imagery are displayed and assessed, the union of the geoimages used to create the georegistrated scenes is executed by iMaG Georegister. Geomasking is process similar to georegistration, for which the geomask is an independent source. Therefore, a geomosaic is a useful by-product of the georegistration and/or geomask process.

An extension of a normal georegistration and a normal geomosaicking is the use of an independent geomask to define the outer limit of each inputted geoscene and, of the georegistered image cube and geomosaic. A geomask contains two kinds of pixels: non-zero-value body pixels and zero-value background pixels. It is the non-zero-value pixels that define the outer limit of each of the trimmed geoscenes. A geomask, of course, may also be a conventional gray tone image. A copy of a scene with DN values are zero is also performed by geomasking using pixel value and region size as controllable parameters. The outputting pixels' DN values can be achieved by comparison between the original scene and its zero-DN copy. Assessing DN-Value change after orthorectification or georegistration is a subset of this inventive system (FIG. 6).

By inputting multiple geoimages into a geomasking analysis, a set of geomasked images is obtained. Each geomasked geoimage is a subset of the corresponding input geoimage to be geomasked, and its resolution is the same as that of its parent geoimage. Since the resolutions of the input scenes vary, the resolutions of the multiple geomasked scenes likewise vary. It should be noted that a geomask or virtual-mask can be based on a named region with an ID code.

Compositing the geomasked and other referenced geoimages together yield a geoindexed geoimage. A variation of the image may be obtained using non-geomasked geoimages as the base and geooverlaying the geomasked geoscenes at the top. To differentiate between the reference geoimages and the geomasked geoscenes, graytones are used to represent the reference geoimages, and colors are used to geolocate the aerial coverage of the geomasked geoscenes.

By mosaicking the output scenes of a geomasking analysis, one obtains a geomosaicked image, whose spatial coverage is complemented by the individual geomasked images.

For visualizing multiple overlapping geomasked sub-scenes, color layers must be ordered to generate a color composite image. Otherwise, a smaller geomasked scene can become invisible because it is buried under a larger geomasked scene that totally surrounds the smaller geomasked scene. The present invention provides a method to order the multiple geomasked scenes to generate a color composite geomosaic.

It should be noted again that the above “geo” prefix can be changed to “virtual” or “no-coordinate” prefix for all the systems discussed.

A conventional vector database comprises a boundary file and a corresponding feature attribute table (FAT). Four complementary data model representations are used in the geoindexing analysis of the invention: (1) raster image, (2) geoindex file, (3) database file (dbf), and (4) various representations of a boundary file. Particularly, the current invention comprises boundary file representations that have not been incorporated in geospatial information system (GIS) literature. A traditional vector representation of a set of boundary pixels is a simple polygon with vertices and arcs, for which few constraints are placed on the structure of vertices and arcs. Once constraints are injected into the polygon system, we have convex polygon, minimum volume bounding box polygon, and numerous derived geometric properties, such as centroids, minimum polygon axis, maximum polygon axis, ratio between min and max axes, compactness shape measure, orientation of the polygon, and so on.

In addition, to encompass new features in vector representation, the current invention provides a novel raster feature that has not been incorporated in the traditional GIS system—the “holes” within a segmented region. Traditionally, these region “holes” are either discounted or simply filled. For the current invention, the hole component of a segmented region is represented by a number of measures serving as bona fide object attributes: (1) the number of holes, (2) the total hole area as a ratio of the total region area—a density measure, (3) the minimum size of the holes, (4) the maximum size of the holes, (5) the average size of the holes, and (6) the frequency distribution of the hole sizes.

Therefore, the feature attribute table of the inventive dual raster/vector database system comprises at least one of the following object attributes:
a) region ID;
b) size;
c) geometric center x-coordinate;
d) geometric center y-coordinate;
e) centroid x-coordinate;
f) centroid y-coordinate;
g) minimum volume bounding box polygon coordinates;
h) width of the region;
i) length of the region;
j) orientation of the region;
k) aspect or width-length ratio;
l) varying shape measures, such as linearity, constriction; convolution, elongation, compactness, etc.;
m) number of holes in the region;
n) solid area to hole area ratio;
o) varying brightness measures: average brightness (tone); maximum tone; minimum tone;
p) varying texture measures: deviation, diversity, neighbor contrasts;
q) percentage of pixels belonging to one of spectral signatures in reference to a signature library including a no-match category;
r) various derived measures from multiple attribute tables, such as velocity, momentum, acceleration, deceleration, bearing data/orientations; and
s) independent data sources like signal or any non-image data with GPS information, and spectral signatures extracted from a multispectral image cube (with multiple images from varying spectral bands/regions), scene or a subset.

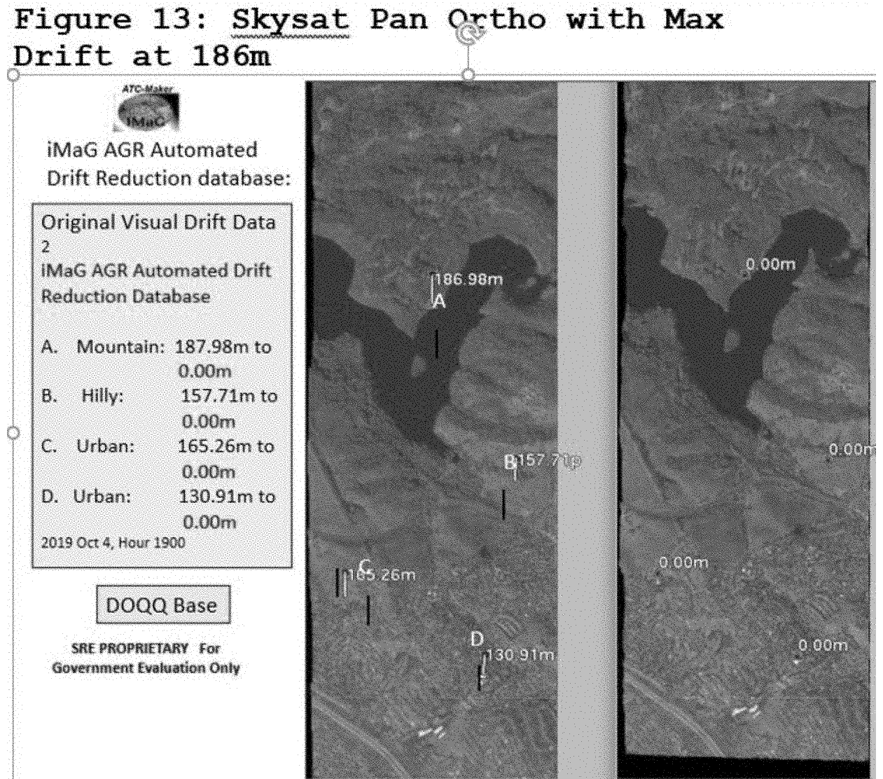

The composite scene of a geomosaic based on multiple geomasked scenes described hereinabove is a raster representation if one considers the spatial distribution of the interior pixels of each geomask subset. The color composite scene, a special case of the composite scene system, is also a vector representation (i.e., the distribution of the boundary pixels can be represented by a solid color). To complete the vector representation, a geoindex file is added to indicate the color system used to color each geomask. A database file specified above that summarizes the geospatial characteristics of each geomasked subset within the overall geomosaicked scenes is also added. A partial listing of a geoindex file is also shown in FIG. 13.

Thus, FIG. 13 shows both raster and vector representations of a composite resulting from a geomasking analysis with multiple geomasked and non-geomasked inputs. As noted above, if COBI is an oblique image, geoindex related data are based on an arbitrary coordinate system, in which the geo-coordinate system is a special case. In addition, the prefix “geo” or “no-coordinate” is inter-changeable with “virtual.”

An overlay may be applied to any generic geoimage or arbitrary coordinate, no-coordinate system base image, for example, an individual image, a georegistered image or a geomosaic. Such an overlay is called a “geooverlay” and the process of applying a geooverlay is called “geooverlaying.” A special kind of overlay is grid-line system that partitions a scene in an n-by-m grid cells for overlaying a raw image or a processing image or both. This program is called simply “geogrid” as a subset of the iMaG AGR system library.

Thus, one possible geooverlay is a set of geogrid lines on the image, the geogrid lines typically corresponding to either a UTM or VTM system or simple xy coordinate system. This overlay is called a “geogrid.” Like any geooverlay, a geogrid may be considered a geospatial feature of the overlaid image. The process of overlaying a geogrid is called “geogridding.” It will be recognized that while geogrid implies a rectangular lattice of reference lines, other geometric patterns, for example a series of concentric circles or other geographic shapes overlaid on a geoimage may also be useful in analyzing and measuring objects and/or areas in geoimages. Consequently, the terms geogrid and geogridding apply to any such overlaid pattern. Here geogrid is a special case of an arbitrary or no-coordinate grid system. A grid can also be an arbitrary grid defined a regular interval distance, such as 500 pixels.

A variation of the geooverlay process is to drape a spectral based feature image on top of a terrain elevation based image, generally known as digital elevation model (DEM). Typically, the DEM is viewed from particular depression angle and a particular aspect angle. The present invention departs significantly from a conventional 3-D visualization/image draping method by using VTM, rather than UTM, as the basis for generating geoimages in both spectral and DEM domains. In reality, UTM is a special case of VTM. Without using the VTM paradigm, both spectral and DEM values will be altered after image registration and consequently, feature and DEM mismatches will occur when spectral images and DEM data are distributed across multiple UTM zones and over both sides of the equator. With an arbitrary coordinate system, DEM can either follow the system or be treated as a constant flat surface.

By georegistering spectral and DEM images in the geospatial domain, or a VTM based virtual Earth coordinate system, the present invention generates a four-dimensional (4-D) image, in which (x,y) lies on the datum plane, z0 represents the terrain elevation, and z1 represents one of the multiple spectral/textural bands.

A terrain contour line connects pixels of equal elevation value. A contour interval is a range value defined by two adjacent contour lines. A geoimage representing a particular contour interval can be generated and matched to a single or multiple spectrally-based geoimages that are georegistered to the DEM image. The results are a geocontour and a geocontour interval, respectively. By overlaying a geocontour or a geocontour interval onto a spectrally-based terrain feature, a geoimage is generated having a set of terrain features that exist within a particular DEM-based geocontour interval. The current invention permits point cloud elevation data, such as those generated by a LIDAR system, to be represented by an image.

By draping the contour-interval based terrain features on a corresponding DEM image viewed from a particular depression and a particular aspect angle, a four dimensional geoimage is obtained in a geo-fly-through scene visualization format is obtained.

One of the special applications of geo-contouring is a choropleth map of drift data of original scene vs. the base.

The method of the present invention provides a Virtual Geospacial Information System (VGIS) having a database of geospacial information contained therein. First, a spatial structure is created to identify any image generated for any region of the world. Each created spatial unit is identified by a unique, standard designation, so information about any identified region may be readily located. For example, a search engine (e.g., Google®) may easily locate information available via the Internet from anywhere in the world. In the UTM system, each defined UTM zone is composed of a region of 6×8 degrees. This size is too large to define practical geospatial information items since one degree is equivalent to approximately 110,000 meters, and each UTM zone is therefore about 660,000 meters by 880,000 meters. This is equivalent to 660,000×880,000 pixels, assuming the resolution of the image is 1 m/pixel.

The resolution of currently available, commercial satellite imagery is already under 1 m/pixel. In order to conform to the existing remote sensing environment, the method of the present invention uses spatial units for a virtual geodatabase covering an area of 7.5 minutes×7.5 minutes. This, incidentally, is the same area as a topographic quadrangle produced by the United States Geological Survey (USGS). Thus, one degree has 8 quads in a linear scale. Globally, there are 2880 geo-quads, computed as follows:

8 quads×360=2880 quads (Eq. 2)

Unlike the UTM system, the inventive VGIS also has 2880 quads defined along the northing direction. Therefore, by using a four-digit system, the first quad can be designated as

0001_0001 (Eq. 3)

And the ID of the last quad is:

2880_2880 (Eq. 4)

Each geoquad may be subdivided into four quarter quads (QQ), each designated by either a numeric ID or a text ID code as follows.

The numeric ID code is:

_00 for the SW QQ;

_50 for the SE QQ;

_05 for the NW QQ; and

_55 for the NE QQ. (Eq. 5)

This VGIS structure (i.e., quads and quarter-quads) may be represented graphically.

As discussed hereinabove, the result of georegistration is a set of images all having the same resolution, the same orientation, and the same dimension. This set of images is identical to a multispectral image cube. If four or more images are available in the image cube, 20 or more additional images may be generated using linear and non-linear combination of the input images. These additionally generated images are called n-transforms, such as rgb (red, green, blue) to hsi (hue, saturation, intensity), be it in a VTM or virtual Earth coordinate or no-coordinate system. For a more generalized system, a system of n-transforms can be generated from at least one image. From a multispectral image cube containing the original images and their resultant n-transforms, an object spectral signature library may be generated. For example, if the object is a particular ground vehicle, a spectral signature of the ground vehicle may be generated by clicking on (i.e., selecting) one pixel of that particular ground vehicle. If the first image is denoted m_1, the second image m_2, and the nth image is m_n. The location of a particular selected pixel located at (i,j) has a pixel value of x_1 at (i,j)=y_1 , a pixel value of x_2 at (i,j)=y_2, and finally, a pixel value of x n at (i,j)=y_n, the following vector may be generated:

[L₁, L₂, . . . , Lₙ] (Eq. 6)

Equation (6) represents the spectral signature of an object. A spectral signature library is composed of the spectral signatures of multiple objects. For a more generalized system, an object can be represented by a group of spectral signatures instead of one.

The present invention provides an automated means to generate n scene-content terrain/object signatures/layers. While traditional methods provides means to generate feature/object layers by two distinct, and usually dichotomous classification methodologies: (1) supervised classification and (2) unsupervised classification as given in the following basic references in ArcGIS10.3: Spatial Analyst Tools>>Multivariate>>Iso Cluster Unsupervised Classification or Maximum Likelihood Classification, or Principal Components. The end result is a set of scene content layers as expressed in Eq. (7) below:

[L₁, L₂, . . . , Lₙ] (Eq. 7)

Under the prevent invention, each pixel is explicitly tied with each signature/layer with a likelihood of association in a 0-255 graytone levels representation. As a result, a terrain/object layer is represented a full-fledged 0-255 graytone image, such as a graytone image presentation of a terrain/object layer being different from a traditional supervised or unsupervised feature/object represented by either 0 or 255 discrete graytone values.

In addition, the present invention provides a means to combine both unsupervised and supervised classification into one system in which the user can flexibly provide how many feature/object layers for unsupervised and how many for the supervised, and how iterations to complete the entire scene-content layer generation. Thus, unsupervised or supervised classification is special case of iMaG Automated Scene Content Signature/Layer Generation system.

Under the iMaG AGR system with multi-orbit imagery, there are at least two sets of Scene Content Signature/Layer Generation systems as represented by Eq. (8):

[L₁, L₂, . . . , Lₙ]_{_time_1}

[L₁, L₂, . . . , Lₙ]_{_time_2} (Eq. 8)

In addition, each pixel in time_₁ imagery possesses a set of likelihood association values tied to each of time_₁ scene-content signatures/layers.

Likewise, each pixel in time_₂ imagery possesses a set of likelihood association values tied to each of time_₂ scene-content layers. Nevertheless, each time_₁ imagery/layer pixel, and time_₂ imagery/layer shares a common geospatial base, because the time_₁ scene and the time_₂ scene are georegistered. By the same principle, there is a likelihood of spatial association between two sets of scene-content layers.

It follows that there is a means to measure the change in the likelihood of association for each pixel, leading to a quantification of spectral-based change over time.

Accordingly, the present invention possesses the following unique features of an automated change detection system (ACD):

(1) It provides a means to perform Automated Change Detection, instead of interactively inputting two “identical” terrain/object layers to delimit the change in terms of (1) no change, (2) growth, and/or (3) shrinkage.
(2) It generates multiple changed features simultaneously, instead of a single feature, one at a time. Since the present invention defines change by the likelihood of association with respect to a predetermined scene-content feature/object signature layers, a given degree of change can be applied to multiple terrain features and objects. For example, a change of >90% can be simultaneously applicable to wetland and a built-up area.
(3) It defines change in terms of a set of scene-content spectral signatures at a given spatial base from time_1 to time_2. It lists the changed spectral signatures by the likelihood of change.
(4) The pixels in the spatial base of the changed feature form a region, and thus, a shapefile that can be represented by a set of boundary and regions descriptors. The sum of all changed regions forms a geospatial information database (GIS) that is searchable by text or a rule base.
(5) The combination of above spectral signature and region base spatial descriptors forms a unique change detection visualization system, and text-searchable GIS system database.
(6) Pair of spectral signatures can be generated by iMaG AGR system. Thus, dissimilar imagery pairs after iMaG AGR provide a database for a comparative assessment of varying georegistration inputs: such as one generated by non-ortho imagery vs. DOQQ, orthoimagery vs. DOQQ, iMaG AGR vs. DOQQ, and so on.

The present invention shown FIG. 1 is based on the VTM system in U.S. Pat. Nos. 7,899,272 and 7,343,051 to minimize distortions in projecting the 3-D Earth's Coordinate System to a 2-D map surface. FIG. 2 is an example of cross UTM zone condition centered on Culpeper, Va. In addition, it provides means to maintain a pixel's geospatial coordinates invariant property in three-way coordinate transform spatial so as to preserve the spectral integrity of the pixel in georegistration, geomosaic, resolution/scale change and so on.

The present invention begins with assignee's iMaG Automated Georegistration (AGR) with two input images: the base and the aligned.

The next step is iMaG AGR orthorectification with RPB and DEM data. Accordingly, FIG. 3 is the input scene of WV2 Sep. 22, 2016 P007 imagery to be aligned with the DOQQ base. FIG. 4 is the corresponding DEM image to orthorectify the input imagery. FIG. 5 is the resultant iMaG AGR orthorectified imagery. FIGS. 6-8 examine the spectral DN value change and its effect on vehicle detection.

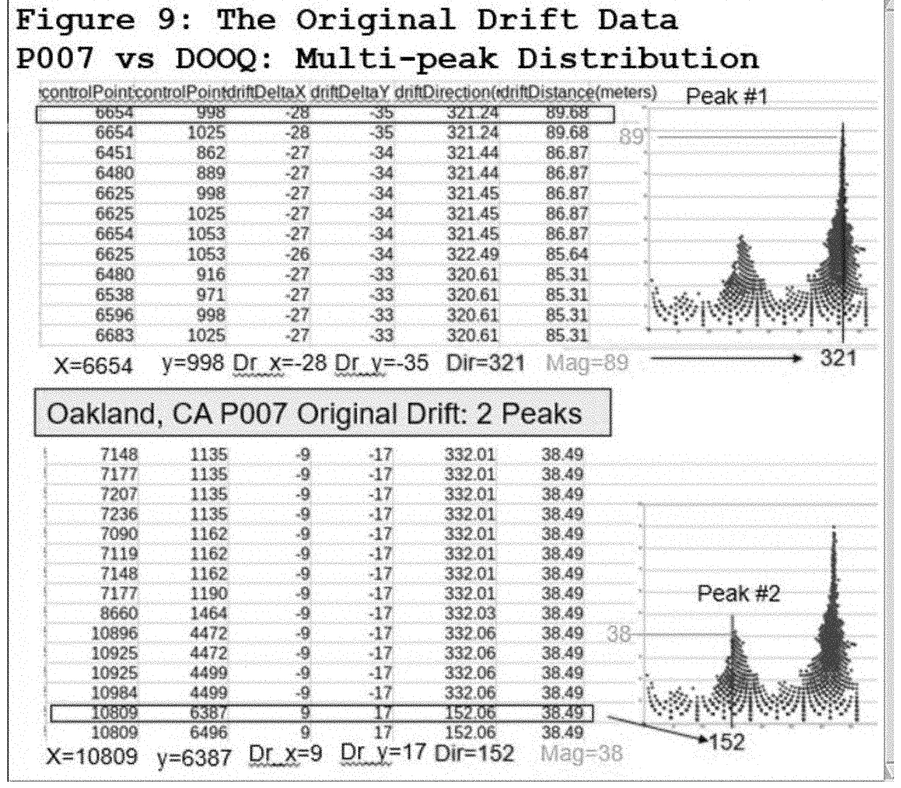

In this present Invention, three sets of drift data are defined. FIG. 9 shows the drift of the original input pair: DOQQ vs. WV2 P007. After iMaG AGR orthorectification, FIG. 10 is generated to show the drift at the orthorectification pair with RPB and DEM if applicable. For example, DOQQ is already an orthoimage, and need not be orthorectified.

A significant difference exists between the distribution of the original drift and the distribution of the orthorectified imagery. The former is characterized by multiple peaks, whereas the latter is characterized by a single peak.

FIG. 11 is the final iMaG AGR automated reduced drift data with zero at 77% level, and 2.8 m or 1-pixel at the 96% of the full scene. The remaining drift>pixel is only 4% of the full scene. Since there is virtually no drift at the final iMaG AGR reduced drift, the distribution of the final drift is insignificant.

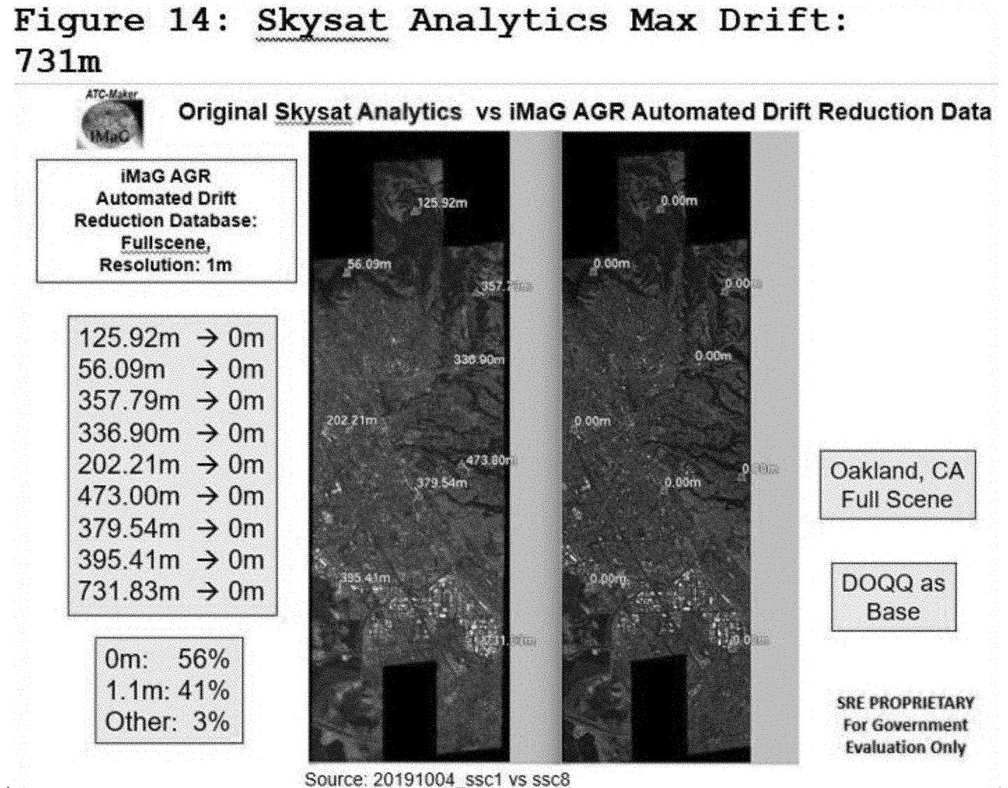

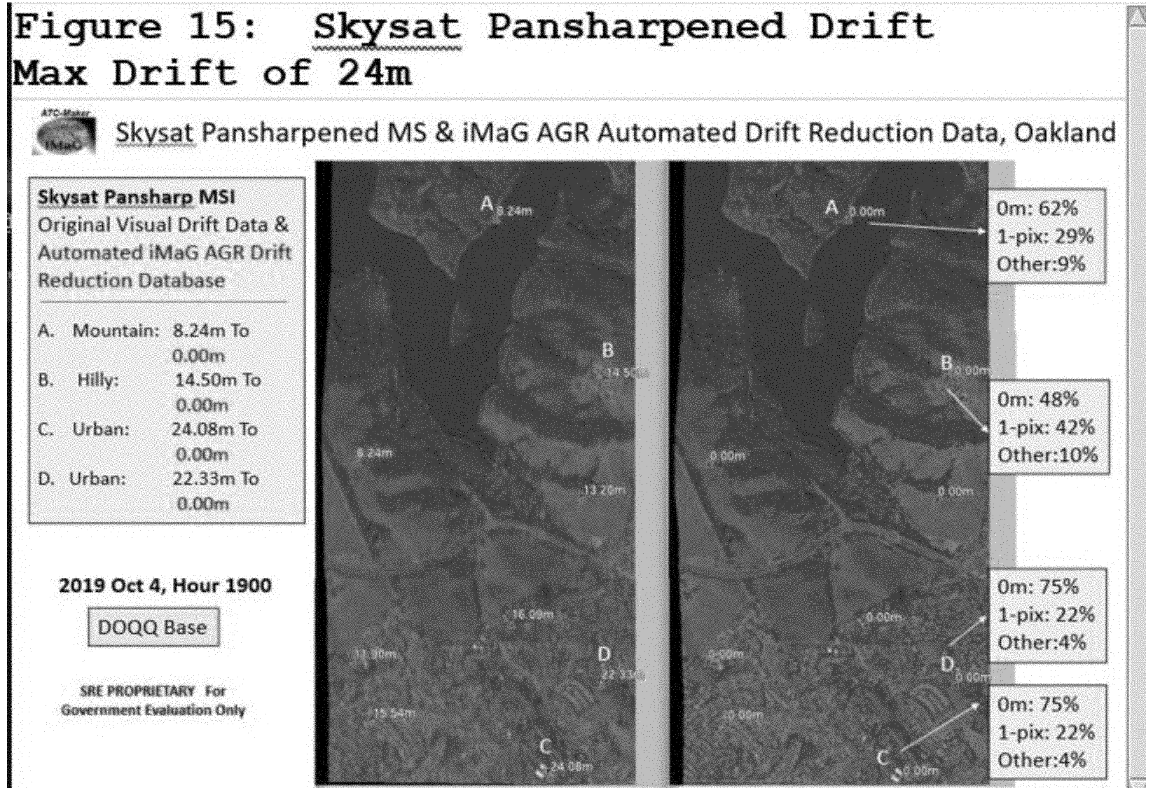

The drift in multi-orbit commercial satellite imagery against either with a DOQQ or itself of another orbit is widespread. FIG. 12 is the original drift of WV2 LV1B multi-orbit imagery, P005 vs P007, with drift magnitude great than 100 m. A similar magnitude of drift is found in more recent Skysat imagery. FIG. 13 is Skysat's Oct. 4, 2019 Pan Ortho imagery with max drift of 186 m. FIG. 14 is Skysat's Analytics imagery with max drift of 739 m. Finally, FIG. 15, Pansharpened imagery, has the max drift magnitude of 24 m. The varying types of terrain drifts are presented as follows:

FIG. 16 is mountain drift from DOQQ vs WV2 Sep. 22, 2019, P007.
FIG. 17 is hilly drift from DOQQ vs. WV2 Sep. 22, 2019, P007.
FIG. 18 is urban drift from DOQQ vs. WV2 Sep. 22, 2019, P007.

Once a set of imagery are georegistered, an opportunity exists to generate georegistered scene-content terrain/object layers, which are different from traditional non-georegistered products.

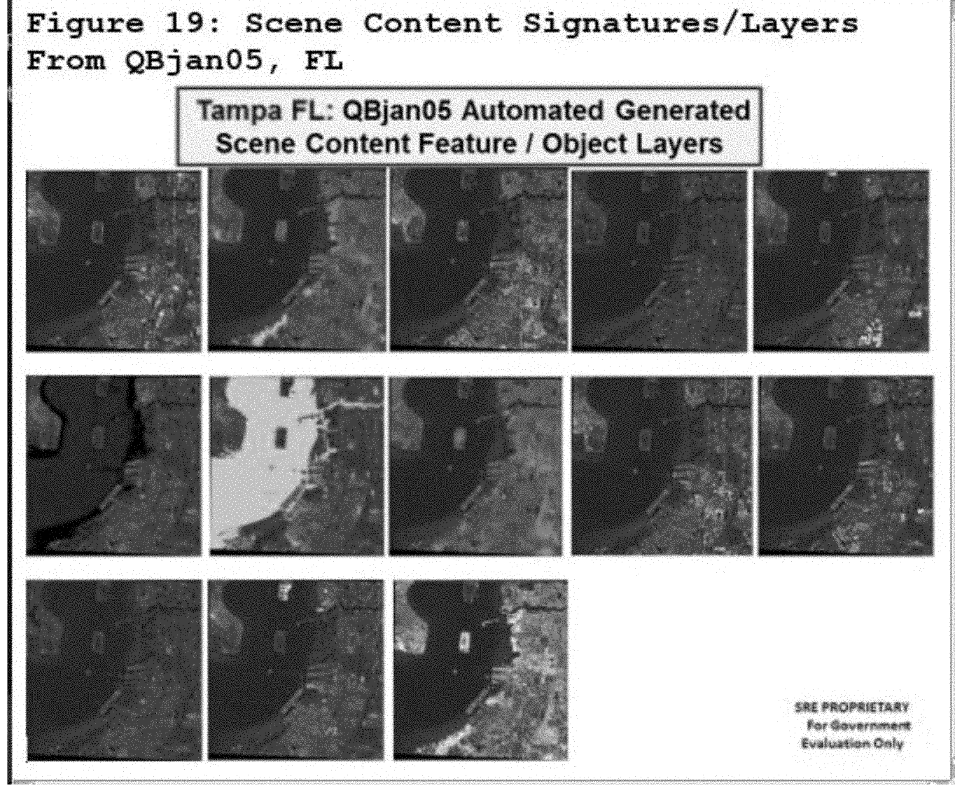

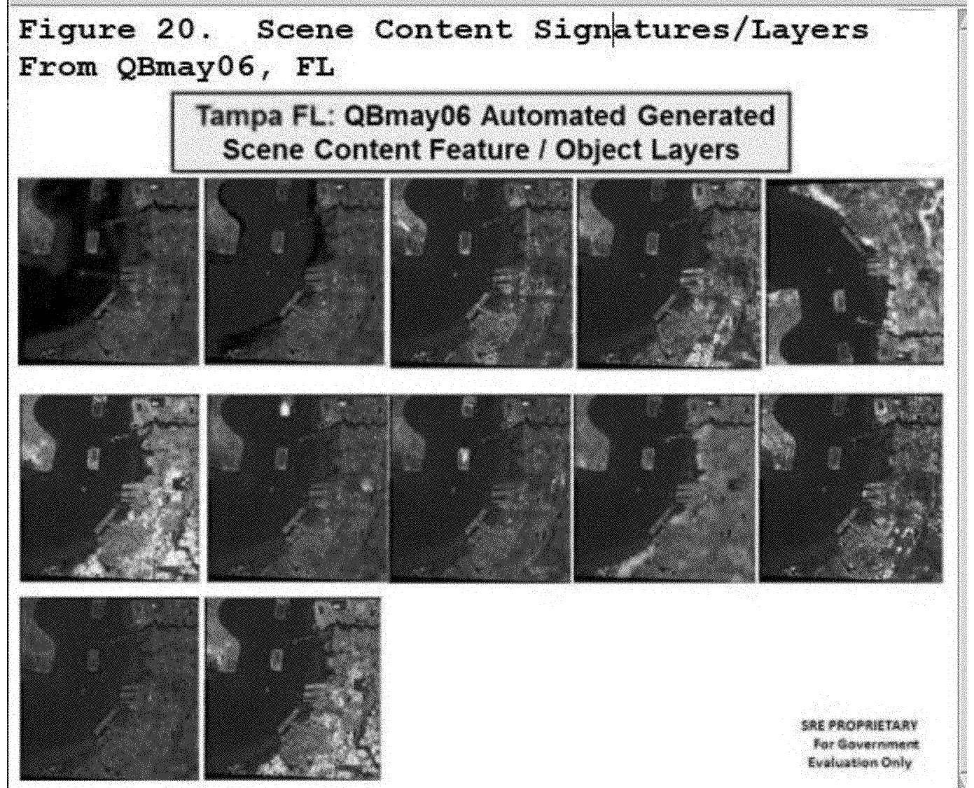

FIG. 19 shows a set of 13 scene content signatures/layers from QBjan05 imagery whereas FIG. 20 shows a set of 12 scene content signatures from QBmay06 imagery that has been automatically georegistered to QBjan05 imagery.

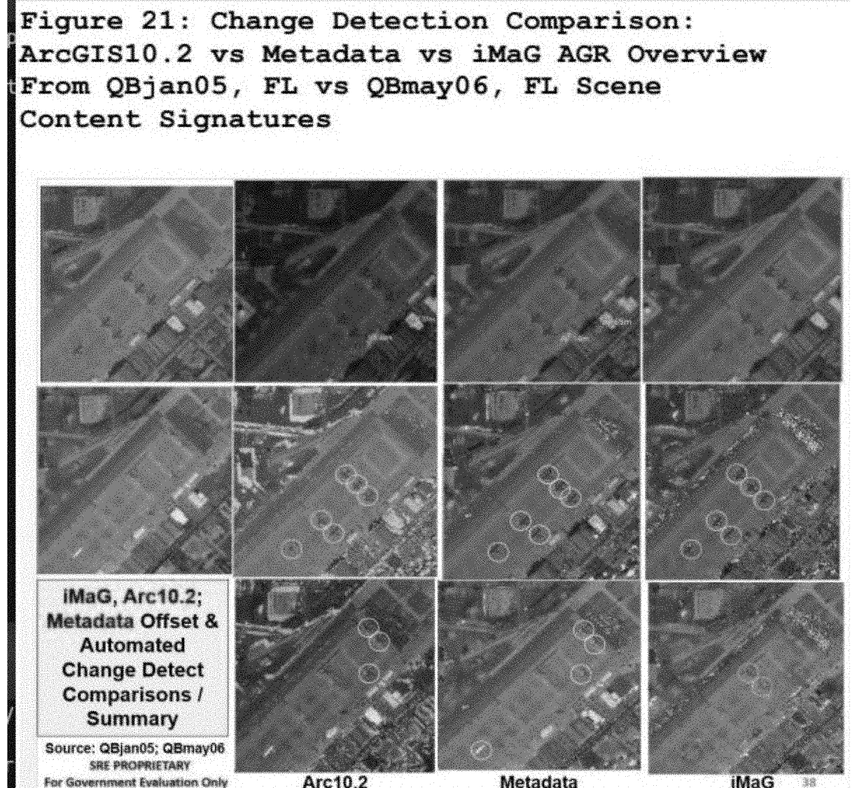

As discussed above, with two sets of georegistered scene-content layers, the iMaG System can proceed to perform automated change detection. In this regard, FIG. 21 shows close-up scenes of QBjan05 and QBmay06 from the NW corner, where jan05 scene has a set of airplanes; in contrast, some old airplanes disappeared, and some new airplanes have appeared. The lower row three images show offsets generated by (1) ArcGIS10.2, (2) metadata, and (3) iMaG AGR.

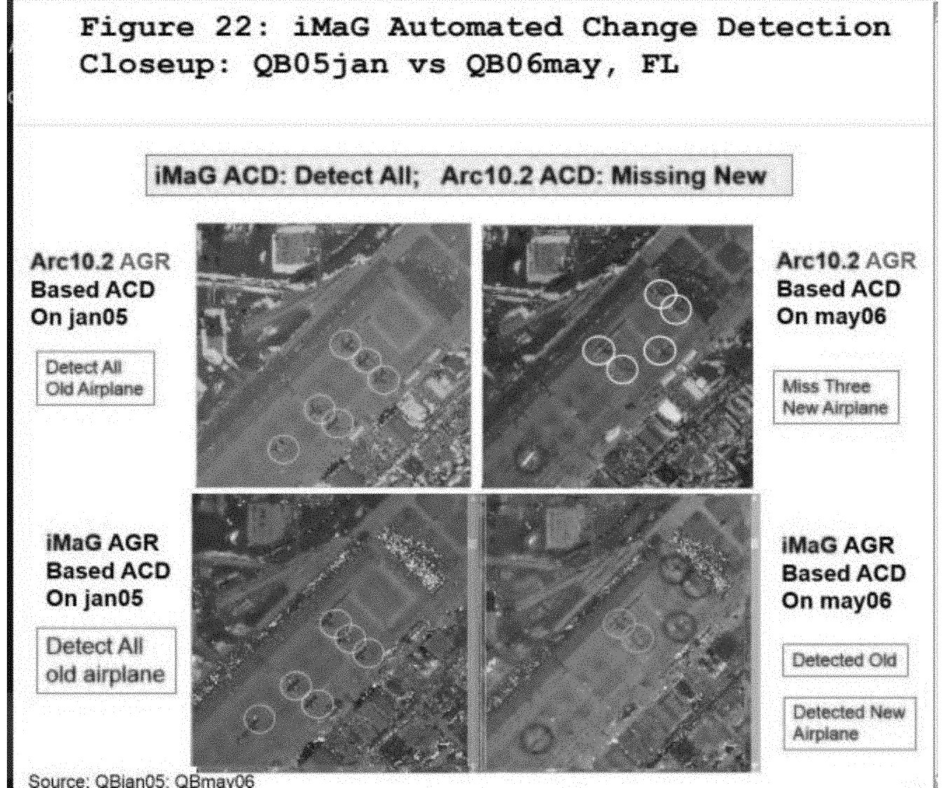

FIG. 22 is an Automated Change Detection (ACD) map where detected pixels are colored. The upper row shows metadata based jan05-left and may06-right detection results.

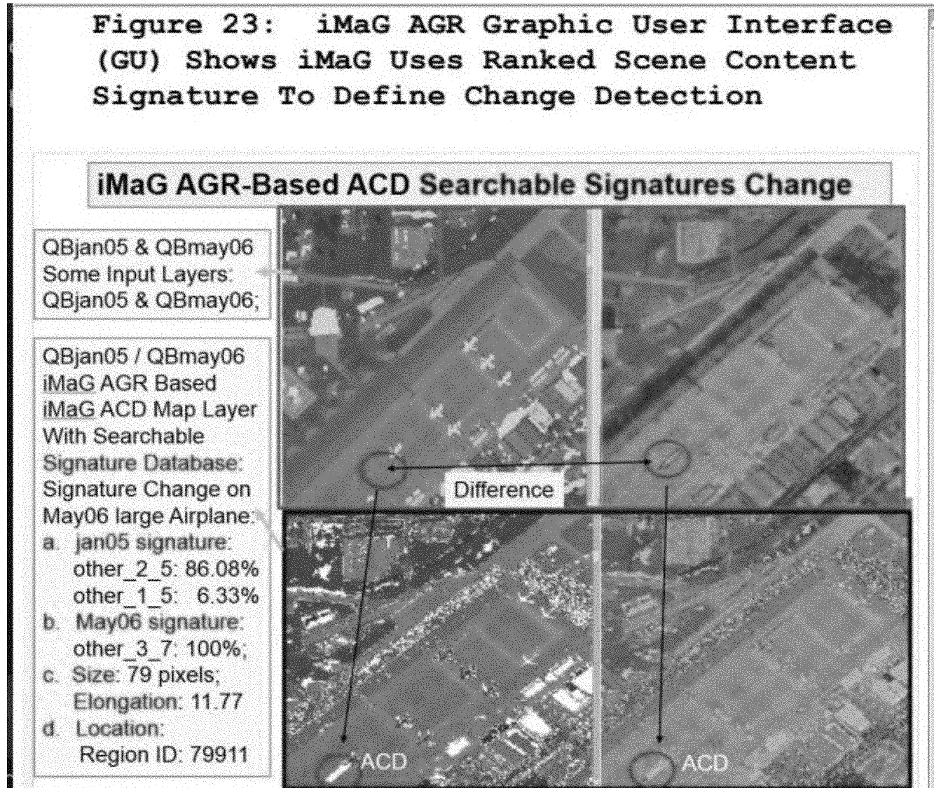

The lower row of FIG. 23 shows iMaG AGR based change detection results: left for jan06, and right for may06.

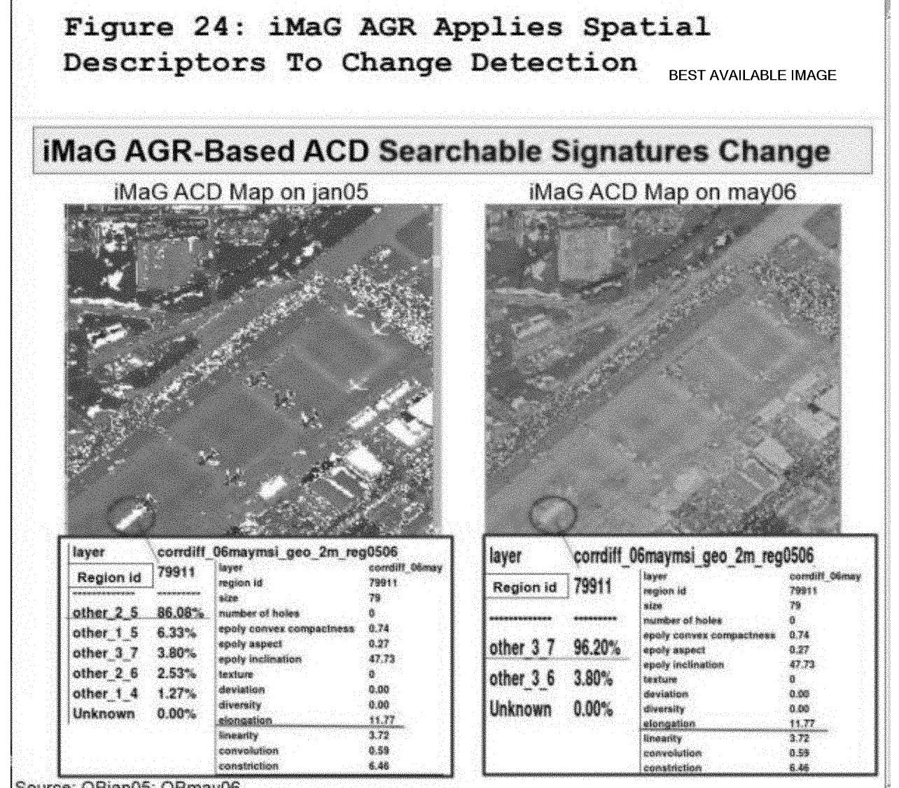

Once the pixels in the change detection map are identified, they can be grouped into regions with Region ID, and linked to various scene content layers as likelihood of association. Since each region has multiple pixels with varying likelihood of associations with multiple scene-content layers, changes at the region level can be defined a set of ranked scene content layers, the more pixels, the higher the rank. Therefore, change detection can be defined by change in spectral signatures with ranked pixel proportions as shown in FIG. 24.

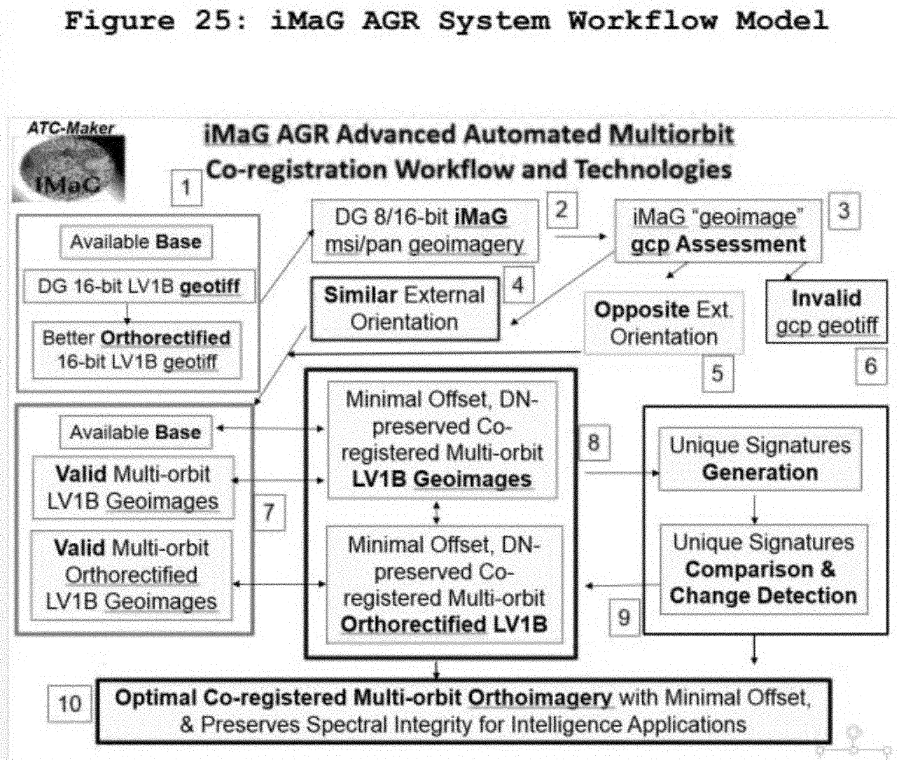

FIG. 25 shows that in addition to change defined by ranked spectral signature components, iMaG AGR provides a set of spatial descriptors for each of the detected changed regions to form a text searchable database in the context of a geospatial information system (GIS).

In summary, multi-orbit geospatial offset is a sum of satellite pointing inaccuracy for which DigitalGlobe's WV2 specification is <500 meter with its demonstrated geolocation offset of 3.5 meters, and terrain effect of varying magnitude.

In this invention, iMaG AGR has achieved the drift reduction to zero meters covering 50% of the full scene, and to 1-pixel drift level covering >95% of the scene, leaving <5% for others. Finally, the entire iMaG Automated Georegistration (AGR) system workflow is shown in FIG. 25 with the following 10 sub-systems:
1) Sub-system_1 ingest the raw input images: Base and the to-be-aligned imagery. In terms of WV2 imagery, LV1B has the raw spectral data without removing the terrain effect, whereas, LV2A is semi-orthorectified with a coarse digital elevation model (DEM). Full-fledged orthorectified imagery is included in this Sub-system.
2) Sub-system_2 converts imagery in Sub-system_1 in the assignee's image format, which is usually 8-bit pgm.
3) Sub-system_3 assesses the quality and characteristics of input geoimages, and classifies them into one of the following three classes as follows.
4) Sub-system_4 takes Sub-system_3 outputs that have similar external orientation.
5) Sub-system_5 takes Sub-system_3 outputs that have dissimilar external orientations.
6) Sub-system_6 stores those imagery with erroneous or inconsistent ground control points (gcps).
7) Sub-system_7 assembles the base imagery and the valid to-be-aligned geoimages.
8) Sub-system_8 perform georegistration with metadata, and iMaG Automated Georegistration.
9) Sub-system_9 generates scene content signatures and subsequent Automated Change Detection.
10) Sub-system_10 outputs Automated Georegistration Results, and

### Automated Scene Content Signature Generation and Automated Change

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application. For example, a reference that is partially inconsistent is incorporated by reference except for the partially inconsistent portion of the reference.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a great number of variations of the devices, device components, and method steps set forth in the present description. As will be obvious to one of skill in the art, methods and devices useful for the present methods can include a great number of optional composition and processing elements and steps.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are claimed, it should be understood that compounds known and available in the art prior to Applicant's invention, including compounds for which an enabling disclosure is provided in the references cited herein, are not intended to be included in any composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of,” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A method of generating a Virtual Geospatial Information System (VGIS) database for recognizing an object in an image, the steps comprising:
a) inputting at least two images, one of the images being a base image for scene registration;
b) generating at least one orthoimage with corresponding digital elevation model (DEM) data in a Virtual Earth Coordinate (VEC) System domain;
c) registering the at least one orthoimage to produce a registered image set; and
d) outputting georegistered imagery with scene content signatures for automated scene content analysis and automated change detection.

2. The method of generating a VGIS database as recited in claim 1, wherein image registration is automated with at least one feature chosen from a set thereof consisting of: a minimized scene characteristic difference between the base image and a to-be-aligned image; a matching strategy chosen from a set of strategies consisting of: a top-down approach, a bottom-up approach, and a combination of a top-down approach and a bottom-up approach; a matching analysis chosen from a set of analyses consisting of, and both a multi-texture-size and a multi-grid-size approach; a matching analysis chosen from a set of analyses consisting of multi-layer, multi-texture and multi-grid-size information integration; matching criteria being flexible and parameter controllable; matching by providing additional tie points through triangulation; evaluating the quality of at least one tie point by eliminating at least one defective tie point; a matching analysis by selecting an image pair from the base images, and another image pair from the to-be-aligned images; a matching analysis chosen from a set of analyses consisting of ortho geoimages and non-ortho geoimages as the base as well as the to-be-matched image; a modification of ground control points in reference to the base; and preserving the spatial and spectral integrity of the base image and the aligned image.

3. The method of generating a VGIS database as recited in claim 1, wherein the orthorectification uses the iMaG AGR orthorectification algorithm that does not violate the spectral integrity of the scene presented in this current patent application specification.

4. The method of generating a VGIS database as recited in claim 1, wherein the image registration process reduces the drift between the base image and the aligned image pair to a predetermined distance.

5. The method of generating a VGIS database as recited in claim 1, wherein the base image is based on cadastral survey data as ground control points (gcps).

6. The method of generating a VGIS database as recited in claim 1, further comprising a feature attribute table (FAT) having dual raster and vector data representations.

7. The method of generating a VGIS database as recited in claim 6, wherein the vector data representation comprises at least model chosen from a set of models consisting of: simple unstructured boundary pixels; chain code data including a chain code histogram; a simple polygon; industry-wide shapefile data; a convex polygon; a minimum volume bounding box (mvb) polygon; and a smoothed polygon.

8. The method of generating a VGIS database as recited in claim 6, wherein the raster image comprises a raster representation of at least one vector data models chosen from a set of vector data models consisting of: simple unstructured boundary pixels; chain code data including a chain code histogram; a simple polygon; industry-wide shapefile data; a convex polygon; a minimum volume bounding box (mvb) polygon; and a smoothed polygon.

9. The method of generating a VGIS database as recited in claim 1, wherein the raster representation further comprises analysis from multispectral data to generate scene content spectral signatures, a spectral signature library, signature matching, and a corresponding feature layer (SSFL).

10. The method of generating a VGIS database as recited in claim 7, wherein the multisensor data comprises at least two data types chosen from a set of data types consisting of:
(a) conventional electro-optical (EO) imagery, satellite imagery, and airborne system equivalents thereof;
(b) real aperture and synthetic aperture radar (SAR) imagery and data;
(c) video/cellphone oblique imagery of varying depression angles;
(d) signal data with GPS information;
(e) thermal imagery (IR);
(f) a mixture of EO and IR imagery and data;
(g) Lidar data and imagery;
(h) terrain elevation data and imagery; and
(i) generic, non-orthoimagery and orthoimagery.

11. The method of generating a VGIS database as recited in claim 1, wherein the generating at least one orthoimage step (b) is performed with a Rational Polynomial Coefficients (RPC) scene camera model.

12. A method of generating a Virtual Geospatial Information System (VGIS) database for recognizing an object in an image, the steps comprising:
a) inputting at least two images, one of the images at least partially overlapping the other image;
b) generating scene content signatures with feature attribute tables from the input images;
c) linking features/objects in the input images based on a feature attribute table data; and
d) outputting a feature attribute table and an object linking/tracking file.

13. The method of generating a VGIS database as recited in claim 12, wherein the feature attribute table comprises dual raster and vector data representations.

14. The method of generating a VGIS database as recited in claim 13, wherein the vector representation comprises at least one vector data model chosen from a set of vector data models consisting of:
(a) simple unstructured boundary pixels;
(b) chain code data including a chain code histogram;
(c) a simple polygon;
(d) industry-wide shapefile data;
(e) a convex polygon;
(f) a minimum volume bounding box (mvb) polygon; and
(g) a smoothed polygon.

15. The method of generating a VGIS database as recited in claim 14, wherein the raster image comprises a raster representation of at least one vector data model chosen from a set of vector data models consisting of:
(h) simple unstructured boundary pixels;
(i) chain code data including a chain code histogram;
(j) a simple polygon;
(k) industry-wide shapefile data;
(l) a convex polygon;
(m) a minimum volume bounding box (mvb) polygon; and
(n) a smoothed polygon.

16. The method of generating a VGIS database as recited in claim 13, wherein the raster representation further comprises analysis from multi spectral data to generate spectral signatures, a spectral signature library, a corresponding feature (SSFL), and automated change detection.

17. A method of generating a Virtual Geospatial Information System (VGIS) database for recognizing an object in an image, the steps comprising:
a) inputting at least two images, one of the images being a base image for scene registration;
b) registering the at least one image in the virtual Earth or no-coordinate domain to produce a reduced drift geo-aligned image set; and
c) outputting the geo-aligned imagery comprising at least one item chosen from a set of items consisting of:
i) scene content signatures,
ii) signature libraries of the base images and the registered image set,
iii) georegistration variance score map,
iv) georegistration drift score database, and
v) change detection.

18. The method of generating a VGIS database in accordance with claim 17, the drift score databases being based on one of a group of sets consisting of:
a) the original input imagery set;
b) the orthorectified imagery set; and
c) the final iMaG AGR reduced drift database set.

19. The method of generating a VGIS database in accordance with claim 18, wherein ground control points (gcps) are based on one of a group of sets consisting of:
a) cadastral survey data;
b) predicted imagery data from the cadastral data;
c) any other appropriate data having high correlation with cadastral data; and
d) other non-image based data with high geospatial accuracy comprising signal and GPS data.
